(19) United States
(12) Patent Application Publication
(10) Pub. No.: US 2005/0273657 A1
(43) Pub. Date: Dec. 8, 2005

(54) Information processing apparatus and method, and recording medium and program for controlling the same

(76) Inventors: Hiroshi Ichiki, Kanagawa (JP); Tetsujiro Kondo, Tokyo (JP); Takafumi Morifuji, Tokyo (JP)

Correspondence Address: William S. Frommer, Esq.;FROMMER LAWRENCE & HAUG LLP, 745 Fifth Avenue, New York, NY, 10151, US

(21) Appl. No.: 11/093,868

(22) Filed: Mar. 30, 2005

(30) Foreign Application Priority Data
Apr. 1, 2004 (JP) 2004-108989
Apr. 14, 2004 (JP) 2004-119009

(51) Int. Cl. G06F 11/00

(52) U.S. Cl. 714/25

(57) ABSTRACT

An information processing apparatus includes acquisition means for acquiring input and output signal formats from each of connected signal processing apparatuses; selection means for selecting a first apparatus from among the signal processing apparatuses; creation means for selecting, from among the signal processing apparatuses, a second apparatus having an input signal format corresponding to an output signal format of the selected first apparatus and for creating a signal path table including a signal path in which the second apparatus is described as an apparatus that receives a processed signal output from the first apparatus; and display means for controlling display of the signal path created in the signal path table.

### CROSS REFERENCES TO RELATED APPLICATIONS

The present invention contains subject matter related to Japanese Patent Application JP 2004-108989 filed in the Japanese Patent Office on Apr. 1, 2004, and Japanese Patent Application JP 2004-119009 filed in the Japanese Patent Office on Apr. 14, 2004, the entire contents of which are incorporated herein by reference.

### BACKGROUND OF THE INVENTION

1. Field of the Invention

The present invention relates to information processing apparatuses and methods and to recording media and programs for controlling the information processing apparatuses and methods, and more particularly, to an information processing apparatus and method for easily connecting a plurality of signal processing apparatuses and to a recording medium and a program for controlling the information processing apparatus and method.

The present invention also relates to an information processing apparatus and method for easily controlling a plurality of apparatuses and to a recording medium and a program for controlling the information processing apparatus and method.

2. Description of the Related Art

For example, in many cases, television receivers and audio apparatuses have been used independently of each other in homes. It is difficult for users to exchange information between television receivers and audio apparatuses that are used independently, and the number of electronic apparatuses used in homes has been increased. Under such a situation, electronic apparatuses have been connected to each other in homes using buses. Thus, users can use the electronic apparatuses as a unified system by organically connecting the electronic apparatuses.

Combining a plurality of apparatuses having different functions into one apparatus to perform multiple functions is suggested, for example, in Japanese Unexamined Patent Application Publication No. 2003-179821.

In addition, recently, the bandwidth of image processing systems for input images has been increased. Thus, large scale integration devices (LSIs) and modules with relatively narrow bandwidths may be arranged in parallel to each other to be operated at the same time. In this case, it is desirable to control many LSIs and modules together. Controlling all the apparatuses independently may cause complexity and require redundant mechanisms. Thus, broadcast control may be used.

In order to control a plurality of apparatuses, a controller outputs a common broadcast control signal to the plurality of apparatuses. Thus, the plurality of apparatuses can be easily controlled.

When broadcast control signals are used, however, it is difficult to find a failure apparatus. This makes it difficult to ensure reliability.

Thus, providing each of the apparatuses to be controlled with a self-diagnosis function is suggested, for example, in Japanese Unexamined Patent Application Publication No. 9-284811. However, since each of the cascade-connected apparatuses is influenced by an apparatus in the previous stage, it is still difficult to find a failure apparatus.

### SUMMARY OF THE INVENTION

In known systems, however, since users give an instruction to connect electronic apparatuses to each other, it is difficult for inexperienced users to use systems in which the electronic apparatuses are connected to each other.

It is desirable to easily and organically connect a plurality of apparatuses to each other to be used without causing users to perform complicated operations.

In addition, if a controller receives acknowledgement (ACK) signals or return signals from apparatuses and controls the apparatuses in accordance with the ACK signals or the return signals, the apparatuses can be reliably operated. However, this is almost the same as the controller independently controlling the apparatuses. Thus, there is no point in using broadcast control signals.

Thus, for example, a procedure, using a watchdog timer (WDT) or the like, for creating a control system with high reliability in the highest layer and acquiring reliability for a lower layer using the reliability in the highest layer is known. Repeating this procedure creates a tree structure that ensures reliability, thus ensuring the reliability of the whole system.

However, even if reliability can be ensured upstream, it is difficult to ensure reliability downstream using the reliability upstream while effectively using broadcast control. This is because there is no point in using broadcast control since the upstream side makes a determination based on a return value from the downstream side.

It is also desirable to reliably control a plurality of apparatuses and to ensure the reliability of the whole system.

An information processing apparatus according to an embodiment of the present invention includes acquisition means for acquiring input and output signal formats from each of connected signal processing apparatuses; selection means for selecting a first apparatus from among the signal processing apparatuses; creation means for selecting, from among the signal processing apparatuses, a second apparatus having an input signal format corresponding to an output signal format of the selected first apparatus and for creating a signal path table including a signal path in which the second apparatus is described as an apparatus that receives a processed signal output from the first apparatus; and display means for controlling display of the signal path created in the signal path table.

The selection means may select an external input apparatus for receiving an external processed signal as the first apparatus, and may select an intermediate apparatus that is not the external input apparatus and that is not an external output apparatus for externally outputting the processed signal after the signal path table for the external input apparatus is created. The creation means may create a signal path-table including a signal-path in which the intermediate apparatus is described as the first apparatus after the signal path table for the external input apparatus is created.

The creation means may eliminate a signal processing apparatus for which the signal path is not established from the signal path table after the signal path table for the intermediate apparatus is created.

The information processing apparatus may further include determination means for determining a signal path in accordance with priorities when the signal path table includes a plurality of signal paths.

The determination means may determine the priorities in accordance with the weight provided in advance to each of the signal processing apparatuses.

The determination means may determine the priorities in accordance with a signal path assumed for each of the signal processing apparatuses.

When a first mode is selected, the display means may display a first parameter input screen for setting a parameter in detail. When a second mode is selected, the display means may display a second parameter input screen for easily setting a parameter.

An information processing method according to an embodiment of the present invention includes the steps of acquiring input and output signal formats from each of connected signal processing apparatuses; selecting a first apparatus from among the signal processing apparatuses; selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and controlling display of the signal path created in the signal path table.

A program of a recording medium according to an embodiment of the present invention includes the steps of acquiring input and output signal formats from each of connected signal processing apparatuses; selecting a first apparatus from among the signal processing apparatuses; selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and controlling display of the signal path created in the signal path table.

A program according to an embodiment of the present invention causes a computer to perform the steps of acquiring input and output signal formats from each of connected signal processing apparatuses; selecting a first apparatus from among the signal processing apparatuses; selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and controlling display of the signal path created in the signal path table.

Accordingly, a signal path table is created in accordance with input and output signal formats of connected signal processing apparatuses, and a signal path created in the signal path table is displayed.

Accordingly, signal processing apparatuses can be connected to each other. In particular, signal processing apparatuses can be easily and organically connected to each other to be used without causing users to perform complicated operations.

An information processing apparatus according to another embodiment of the present invention includes output means for outputting a broadcast control signal; a plurality of processing means for processing a signal input from a previous stage and outputting the processed signal to a subsequent stage when the broadcast control signal is received and for outputting an error signal when the processed signal is not received from the previous stage within a predetermined time set in advance after receiving the broadcast control signal; reception means for receiving the error signal output from each of the plurality of processing means; and determination means for determining which processing means from among the plurality of processing means has a failure in accordance with the error signal received by the reception means.

The plurality of processing means may output the processed signal and a synchronous control signal that is equal to the broadcast control signal to the subsequent stage.

An information processing method according to another embodiment of the present invention includes the steps of performing a plurality of processings for processing a signal input from a previous stage and outputting the processed signal to a subsequent stage when a broadcast control signal is received and for outputting an error signal when the processed signal is not received from the previous stage within a predetermined time set in advance after receiving the broadcast control signal; receiving the error signal output by each of the plurality of processings; and determining which processing from among the plurality of processings has a failure in accordance with the error signal received by the receiving step.

A program of a recording medium according to another embodiment of the present invention includes the steps of performing a plurality of processings for processing a signal input from a previous stage and outputting the processed signal to a subsequent stage when a broadcast control signal is received and for outputting an error signal when the processed signal is not received from the previous stage within a predetermined time set in advance after receiving the broadcast control signal; receiving the error signal output by each of the plurality of processings; and determining which processing from among the plurality of processings has a failure in accordance with the error signal received by the receiving step.

A program according to another embodiment of the present invention causes a computer to perform the steps of performing a plurality of processings for processing a signal input from a previous stage and outputting the processed signal to a subsequent stage when a broadcast control signal is received and for outputting an error signal when the processed signal is not received from the previous stage within a predetermined time set in advance after receiving the broadcast control signal; receiving the error signal output by each of the plurality of processings; and determining which processing from among the plurality of processings has a failure in accordance with the error signal received by the receiving step.

Accordingly, a signal path table is created in accordance with input and output signal formats of connected signal processing apparatuses, and a signal path created in the signal path table is displayed.

Accordingly, a plurality of signal processing apparatuses can be connected to each other. In particular, the reliability in controlling a plurality of signal processing apparatuses can be ensured.

### BRIEF DESCRIPTION OF THE DRAWINGS

FIG. 1 is a block diagram of an example of the structure of an information processing system according to an embodiment of the present invention;

FIG. 2 is a block diagram of an example of the structure of a signal processing apparatus shown in FIG. 1;

FIG. 3 illustrates an example of processing type information;

FIG. 4 is an illustration for explaining input and output signal formats;

FIG. 5 is a block diagram of an example of the structure of a system controller shown in FIG. 1;

FIG. 6 is a flowchart of a signal path table creation process;

FIG. 7 is another flowchart of the signal path table creation process;

FIG. 8 illustrates an example of a processing apparatus table;

FIG. 9 illustrates an example of a signal path table;

FIG. 10 illustrates another example of the signal path table;

FIG. 11 illustrates another example of the signal path table;

FIG. 12 illustrates another example of the signal path table;

FIG. 13 illustrates another example of the signal path table;

FIG. 14 illustrates an example of signal paths;

FIG. 15 illustrates a signal path;

FIG. 16 illustrates another signal path;

FIG. 17 illustrates another signal path;

FIG. 18 illustrates another signal path;

FIG. 19 is a block diagram of an example of the functional structure of a priority assigning section shown in FIG. 5;

FIG. 20 is a flowchart of a priority assigning process;

FIG. 21 is an illustration for explaining addition of priority weights;

FIG. 22 is a block diagram of another example of the functional structure of the priority assigning section shown in FIG. 5;

FIG. 23 is a flowchart of another priority assigning process;

FIG. 24 illustrates an example of default priorities;

FIG. 25 is an illustration for explaining priorities of assumed signal paths;

FIG. 26 is an illustration for explaining corrected priorities of a signal path;

FIG. 27 is a block diagram of an example of the functional structure of a parameter setting section shown in FIG. 5;

FIG. 28 is a flowchart of a parameter setting process;

FIGS. 29A and 29B illustrate examples of parameter input screens;

FIG. 30 illustrates an example of a parameter input screen;

FIG. 31 is a block diagram of an example of the structure of a personal computer;

FIG. 32 is a block diagram of an example of the functional structure of a television receiver according to another embodiment of the present invention;

FIG. 33 is a block diagram of an example of the functional structure of a main controller shown in FIG. 32;

FIG. 34 is a flowchart of a control process;

FIG. 35 is an illustration for explaining a functional structure when a control signal for converting an interlace SD signal into a progressive HD signal is input;

FIG. 36 is an illustration for explaining a functional structure when a control signal for converting an interlace SD signal into a progressive SD signal is input;

FIG. 37 is a block diagram of an example of the functional structure of a Y/C separator shown in FIG. 32;

FIG. 38 is a flowchart of an individual process;

FIG. 39 is a block diagram of an example of the functional structure of a failure determination section shown in FIG. 32;

FIG. 40 is a flowchart of a failure determination process;

FIG. 41 is a block diagram of another example of the functional structure of the television receiver according to another embodiment of the present invention; and

FIGS. 42A and 42B are illustrations for explaining divided regions.

### DESCRIPTION OF THE PREFERRED EMBODIMENTS

An embodiment of the present invention will be described below.

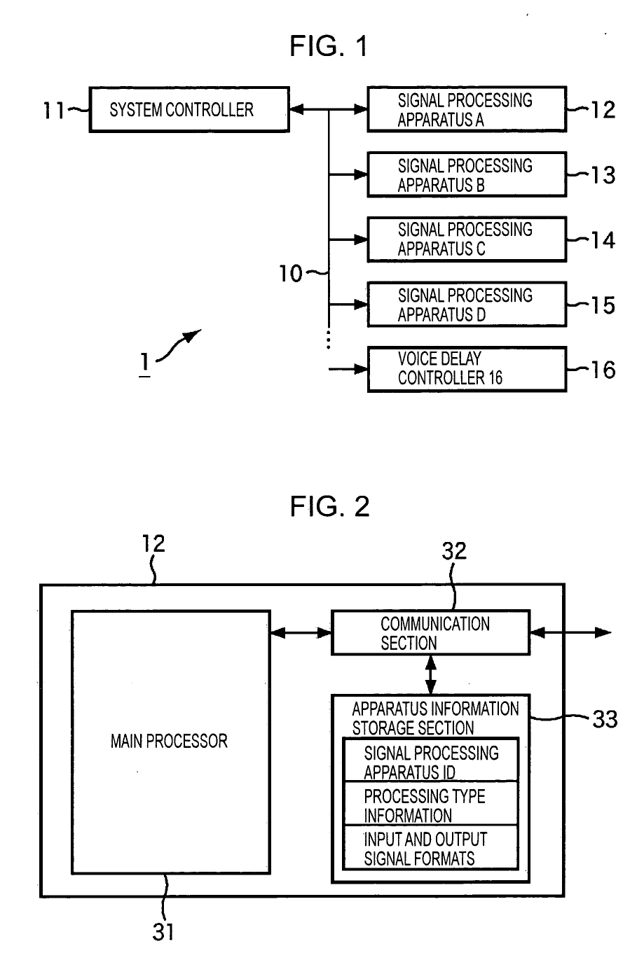

FIG. 1 shows an example of the structure of an information processing system according to this embodiment of the present invention. Referring to FIG. 1, an information processing system 1 includes a system controller 11 and signal processing apparatuses 12 to 15. The system controller 11 is connected to each of the signal processing apparatuses 12 to 15 via a bus 10. According to need, a voice delay controller 16 is connected to the bus 10.

The signal processing apparatuses 12 to 15 are referred to as signal processing apparatuses A to D, respectively, according to need. Each of the signal processing apparatuses 12 to 15 may be an apparatus that functions independently. Alternatively, when the signal processing apparatuses 12 to 15 are installed as substrates in an apparatus, they may function as the unified apparatus.

FIG. 2 shows an example of the functional structure of the signal processing apparatus 12 (or signal processing apparatus A). Referring to FIG. 2, the signal processing apparatus 12 includes a main processor 31, a communication section 32, and an apparatus information storage section 33.

The communication section 32 communicates with other signal processing apparatuses, as well as with the system controller 11, via the bus 10. The apparatus information storage section 33 stores in advance a signal processing apparatus ID, processing type information, and input and output signal formats of the signal processing apparatus 12. The apparatus information storage section 33 includes, for example, a microprocessor, a random-access memory (RAM), and a read-only memory (ROM). It is obvious that the apparatus information storage section 33 can be a RAM, a flash ROM, or a control circuit. The main processor 31 controls the operation of the signal processing apparatus 12.

Although not illustrated, basically, each of the signal processing apparatuses 13 to 15 and the voice delay controller 16 has a similar structure to that shown in FIG. 2.

The signal processing apparatus ID is an identification number unique to each signal processing apparatus and used for identifying the signal processing apparatus.

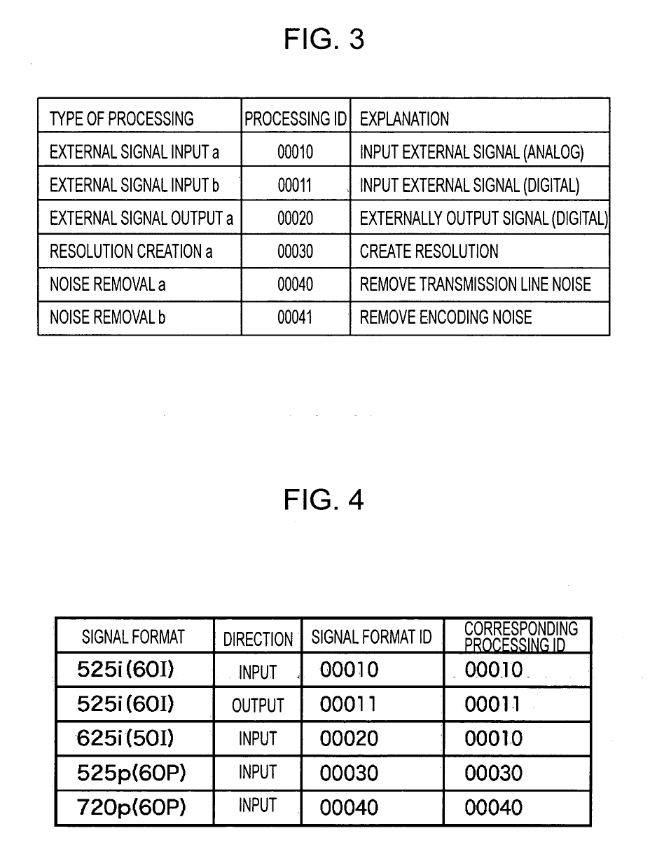

The processing type information is information on processing that can be performed by the signal processing apparatus. FIG. 3 shows an example of the processing type information.

In FIG. 3, processing of external signal inputs a and b, an external signal output a, resolution creation a, and noise removal a and b is shown. Processing IDs, 00010, 00011, 00020, 00030, 00040, and 00041 are provided to the external signal inputs a and b, the external signal output a, the resolution creation a, and the noise removal a and b, respectively.

The external signal input a means processing for inputting external analog signals. The external signals are input without using the bus 10. The external signal input b means processing for inputting external digital signals. The external signal output a means processing for externally outputting digital signals. The signals are externally output without using the bus 10.

The resolution creation a means processing for creating resolution. The noise removal a means processing for removing transmission line noise. The noise removal b means processing for removing encoding noise.

The apparatus information storage section 33 of each signal processing apparatus stores the type of processing performed by the signal processing apparatus as processing type information.

In addition, the minimum necessary information for controlling the interior of the system, information used for user interfaces, and the like may be stored as the processing type information.

The input and output signal formats mean signal formats that can be used for input and output by the signal processing apparatus. FIG. 4 shows an example of input and output signal formats. In the example in FIG. 4, 525i(60I) input and output signal formats are described. The signal format ID and corresponding processing ID for input are 00010 and 00010, respectively. The signal format ID and corresponding processing ID for output are 00011 and 00011, respectively.

In addition, the signal format ID and corresponding processing ID for 625i(50I) input signal format are 00020 and 00010, respectively. The signal format ID and corresponding processing ID for 525p(60P) input signal format are 00030 and 00030, respectively. The signal format ID and corresponding processing ID for 720p(60P) input signal format are 00040 and 00040, respectively.

In FIG. 4, for example, the numeral “525” represents the number of scanning lines, and the numeral “60” in “60I” represents the number of frames. The letter “I” represents an interlace method, and the letter “P” represents a progressive (line-sequential) method.

The apparatus information storage section 33 of each signal processing apparatus stores input and output signal formats corresponding to the signal processing apparatus.

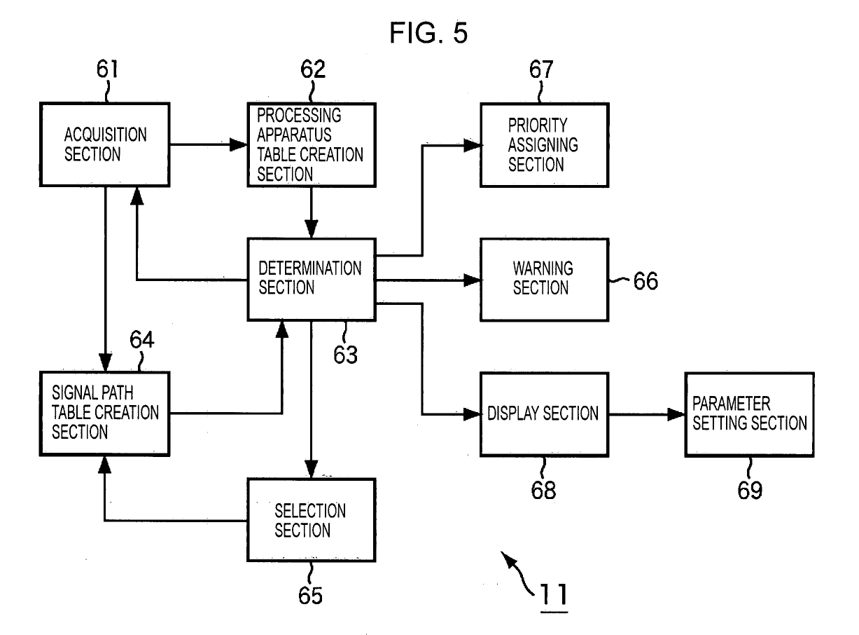

FIG. 5 shows an example of the functional structure of the system controller 11. An acquisition section 61 acquires a signal processing apparatus ID, processing type information, and input and output signal formats from each of the signal processing apparatuses 12 to 15. A processing apparatus table creation section 62 creates a processing apparatus table for specifying an apparatus that is connected to the bus 10 in accordance with the signal processing apparatus ID acquired by the acquisition section 61. A determination section 63 determines whether or not there is any change in the processing apparatus table, whether or not there is any external input apparatus, whether or not there is any intermediate apparatus, whether or not there is any unestablished signal path, and whether or not there is a plurality of signal paths.

A signal path table creation section 64 creates and stores a signal path table indicating a signal path of signal processing apparatuses connected to the bus 10. A selection section 65 performs various types of selection processing in accordance with a determination result of the determination section 63. A warning section 66 gives various types of warning to users in accordance with the determination result of the determination section 63. A priority assigning section 67 assigns priorities to a plurality of signal paths. A display section 68 controls the display of a determined signal path and a parameter input screen. A parameter setting section 69 sets parameters in accordance with the parameter input screen displayed by the display section 68.

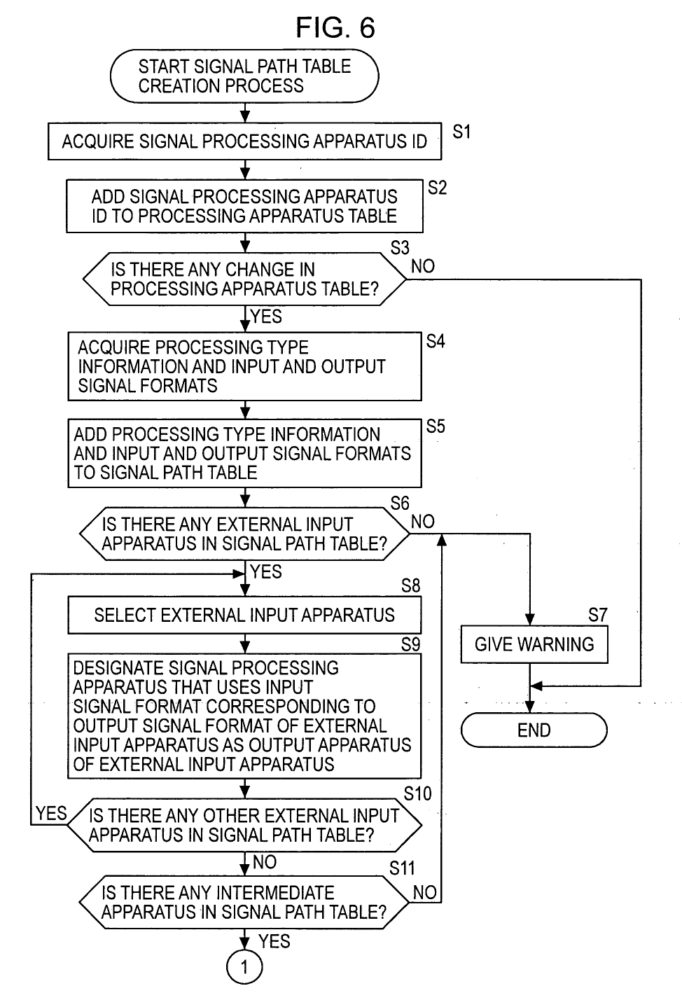

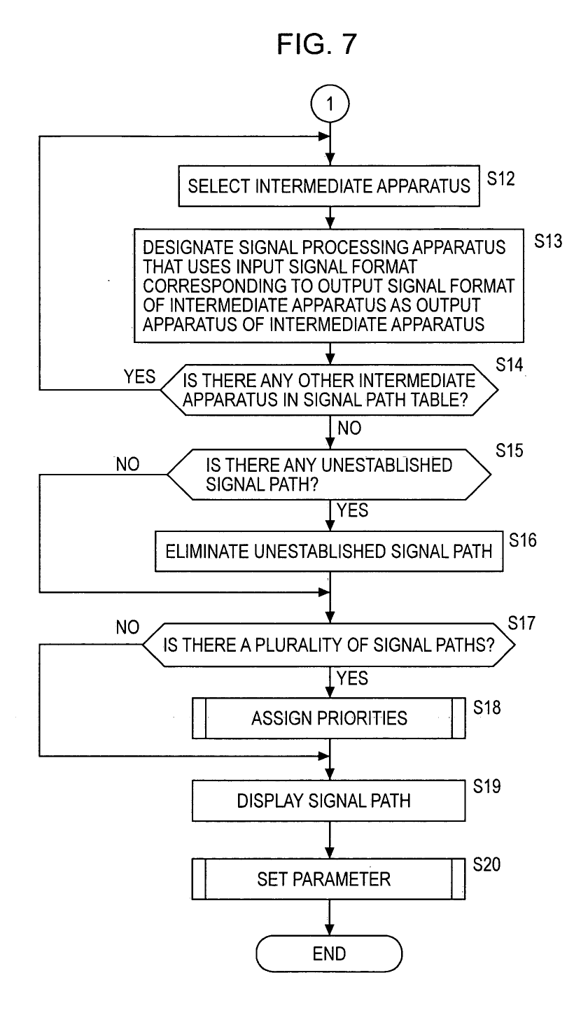

A signal path table creation process is described next with reference to flowcharts in FIGS. 6 and 7. This process is performed, for example, immediately after the power of the system controller 11 is turned on.

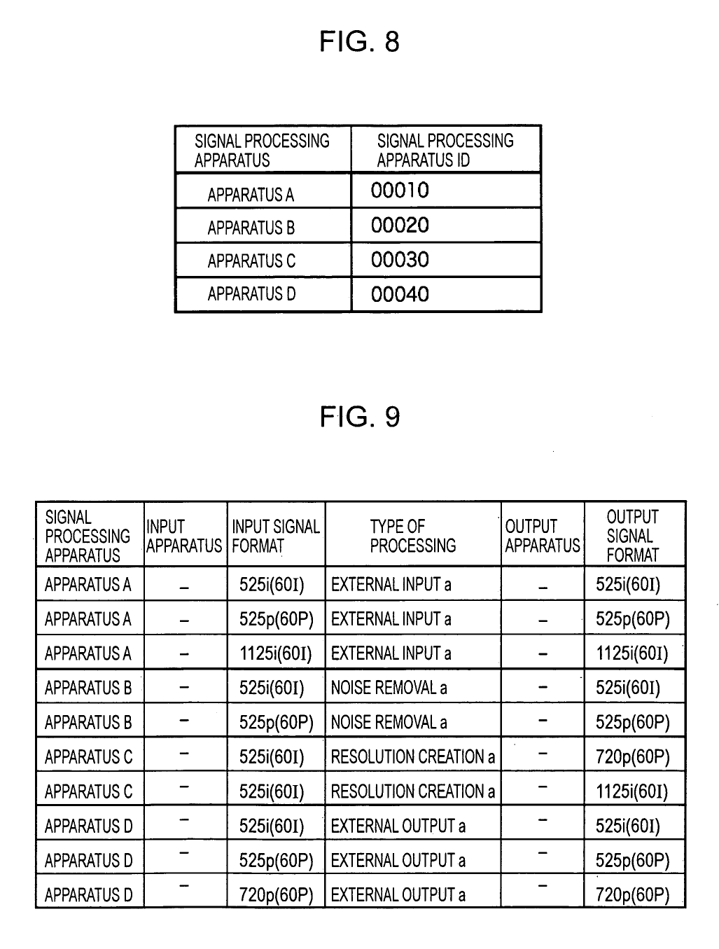

In step S1, the acquisition section 61 acquires a signal processing apparatus ID. More specifically, the acquisition section 61 requests each signal processing apparatus to send a signal processing apparatus ID via the bus 10. The signal processing apparatus reports the signal processing apparatus ID, which is stored in the apparatus information storage section 33, to the system controller 11 via the bus 10. In step S2, the processing apparatus table creation section 62 adds the signal processing apparatus ID to a processing apparatus table. More specifically, the processing apparatus table creation section 62 adds the signal processing apparatus ID supplied from the acquisition section 61 to the processing apparatus table stored in the processing apparatus table creation section 62. Since the signal processing apparatuses A to D are connected in the example shown in FIG. 1, a processing apparatus table shown in FIG. 8 is created. In the example shown in FIG. 8, the signal processing apparatuses A, B, C, and D indicate the names of signal processing apparatuses, and 00010, 00020, 00030, and 00040 are described as the signal processing apparatus IDs for the signal processing apparatuses A, B, C, and D, respectively.

In step S3, the determination section 63 determines whether or not there is any change in the processing apparatus table. In other words, the determination section 63 compares a processing apparatus table created when the power was previously turned on with a processing apparatus table created when the power is turned on this time. If there is no change between the processing apparatus tables, since a signal path table, which will be described below, has already been created, the process ends.

In contrast, if the determination section 63 determines that there is any change in the processing apparatus table in step S3, the acquisition section 61 acquires processing type information and input and output signal formats in step S4. More specifically, the acquisition section 61 requests a signal processing apparatus that is added to the processing apparatus table created this time to send processing type information and input and output signal formats. The requested signal processing apparatus reads the processing type information and input and output signal formats stored in the apparatus information storage section 33, and reports them to the system controller 11 via the bus 10.

The acquisition section 61 supplies the acquired processing type information and input and output signal formats to the signal path table creation section 64. In step S5, the signal path table creation section 64 adds the processing type information and input and output signal formats supplied from the acquisition section 61 to a signal path table, and creates a new signal path table. In a case where the power of the system controller 11 is turned on for the first time, since there is no processing apparatus table or signal path table, a processing apparatus table and a signal path table for all the connected signal processing apparatuses are created. FIG. 9 shows an example of a signal path table created as described above.

In the example shown in FIG. 9, for the signal processing apparatus A, an external input a is provided as the type of processing. A format 525i(60I), 525p(60P), or 1125i(60I) is used as the input signal format. Similarly, a format 525i(60I), 525p(60P), or 1125i(60I) is used as the corresponding output signal format. In other words, the external input a means that a signal is output using the same signal format as the input.

For the signal processing apparatus B, noise removal a is provided as the type of processing. A format 525i(60I) or 525p(60P) is used as the input signal format. In accordance with this input signal format, a format 525i(60I) or 525p(60P) is used as the output signal format.

In other words, in the noise removal a, the signal processing apparatus B removes noise in the signal that is input in the 525i(60I) or 525p(60P) input signal format, and outputs the signal in the corresponding output signal format, that is, the 525i(60I) or 525p(60P) format.

For the signal processing apparatus C, resolution creation a is provided as the type of processing. A format 525i(60I) is used as the input signal format, and a format 720p(60P) or 1125i(60I) is used as the output signal format.

The signal processing apparatus C creates resolution of the signal that is input in the 525i(60I) input signal format, and then outputs the signal in the 720p(60P) or 1125i(60I) output signal format.

For the signal processing apparatus D, an external output a is provided as the type of processing. A format 525i(60I), 525p(60P), or 720p(60P) is used as the input signal format, and in accordance with this input signal format, a format 525i(60I), 525P(60P), or 720p(60P) is used as the output signal format.

In other words, the signal processing apparatus D has a function that an input signal is output in the same format as the input.

Referring back to FIG. 6, in step S6, the determination section 63 determines whether or not there is any external input apparatus in the signal path table. In the signal path table shown in FIG. 9, the signal processing apparatus A functions as an external input apparatus. If there is no external input apparatus in the signal path table, connection processing cannot be performed. Thus, if the determination section 63 determines that there is no external input apparatus in the signal path table, the warning section 66 gives a warning in step S7. More specifically, a message, such as “Connection cannot be performed since there is no external input apparatus.”, is presented to a user.

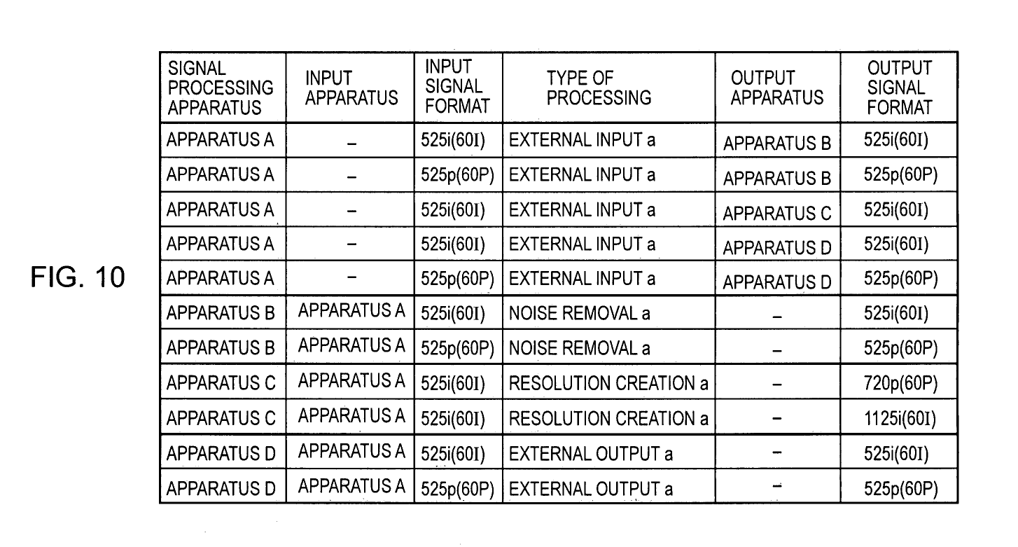

If the determination section 63 determines that there is any external input apparatus in the signal path table, the selection section 65 selects an external input apparatus in step S8. In other words, the selection section 65 selects an external input apparatus from among apparatuses described in the processing apparatus table. For example, the selection section 65 selects the signal processing apparatus A. In step S9, the signal path table creation section 64 designates a signal processing apparatus that uses an input signal format corresponding to an output signal format of the external input apparatus as an output apparatus of the external input apparatus. More specifically, the signal processing apparatus A selected in step S8 uses an output signal format of 525i(60I), 525p(60P), or 1125i(60I). Each of the signal processing apparatus B (525i(60I), 525p(60P)), the signal processing apparatus C (525i(60I)), and the signal processing apparatus D (525i(60I), 525p(60P)) has an input signal format corresponding to any of the output signal formats of the signal processing apparatus A. Thus, each of the signal processing apparatuses B, C, and D is described in the signal path table as an output apparatus of the signal processing apparatus A, as shown in FIG. 10. Similarly, the signal processing apparatus A is described in the signal path table as an input apparatus of each of the signal processing apparatuses B, C, and D, as shown in FIG. 10.

Accordingly, a signal path in which an output of the signal processing apparatus A is supplied to the signal processing apparatus B, C, or D is created.

In step S10, the determination section 63 determines whether or not there is any other external input apparatus in the signal path table. If there is any other external input apparatus, the process returns to step S8 to select another external input apparatus. Then, in step S9, the signal path table creation section 64 creates a signal path table for the selected external input apparatus.

In the example of the signal path table shown in FIGS. 9 and 10, only the signal processing apparatus A exists as an external input apparatus. Thus, the process proceeds from step S10 to step S11. In step S11, the determination section 63 determines whether or not there is any intermediate apparatus in the signal path table. Intermediate apparatuses are apparatuses that are not external input apparatuses or external output apparatuses. In other words, intermediate apparatuses are apparatuses disposed between external input apparatuses and external output apparatuses. If there is no intermediate apparatus in a signal path table, a processed signal input from an external input apparatus is output to an external output apparatus without any processing. Thus, actually, a signal path is not created. In this case, in step S7, the warning section 66 displays a message, such as “There is no apparatus to be connected.”

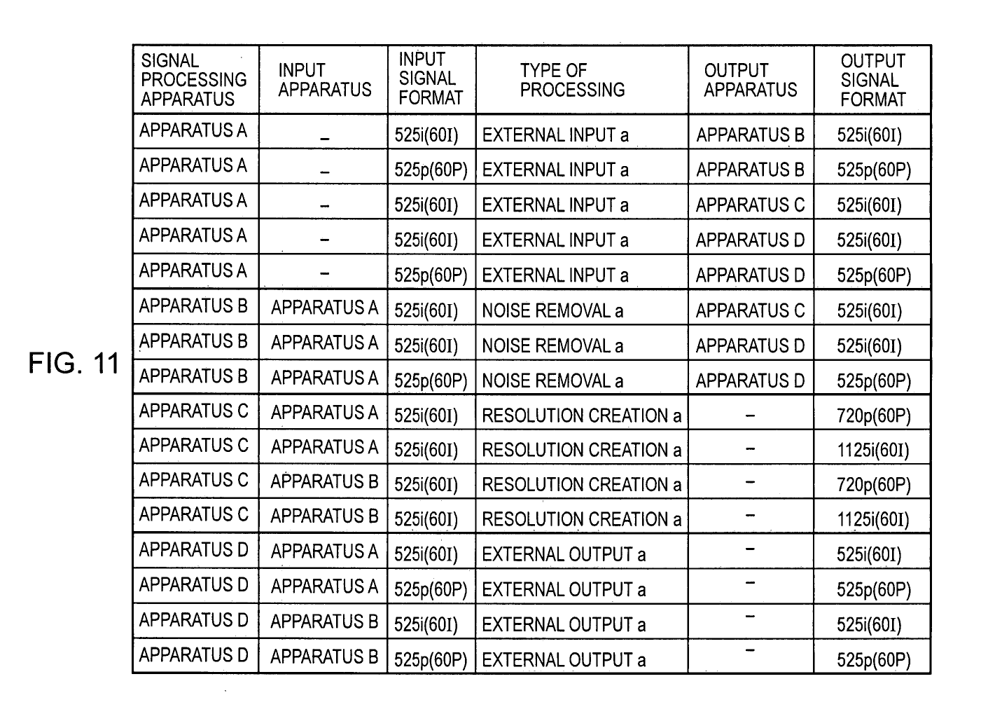

If the determination section 63 determines that there is any intermediate apparatus in the signal path table in step S11, the selection section 65 selects an intermediate apparatus from the signal path table in step S12. In the signal path table shown in FIGS. 9 and 10, each of the signal processing apparatuses B and C is an intermediate apparatus. In step S12, the selection section 65 selects, for example, the signal processing apparatus B. In step S13, the signal path table creation section 64 designates a signal processing apparatus that uses an input signal format corresponding to an output signal format of the intermediate apparatus as an output apparatus of the intermediate apparatus. Thus, for example, each of the signal processing apparatuses C and D is described as an output apparatus of the signal processing apparatus B, and the signal processing apparatus B is described as an input apparatus of each of the signal processing apparatuses C and D, as shown in FIG. 11.

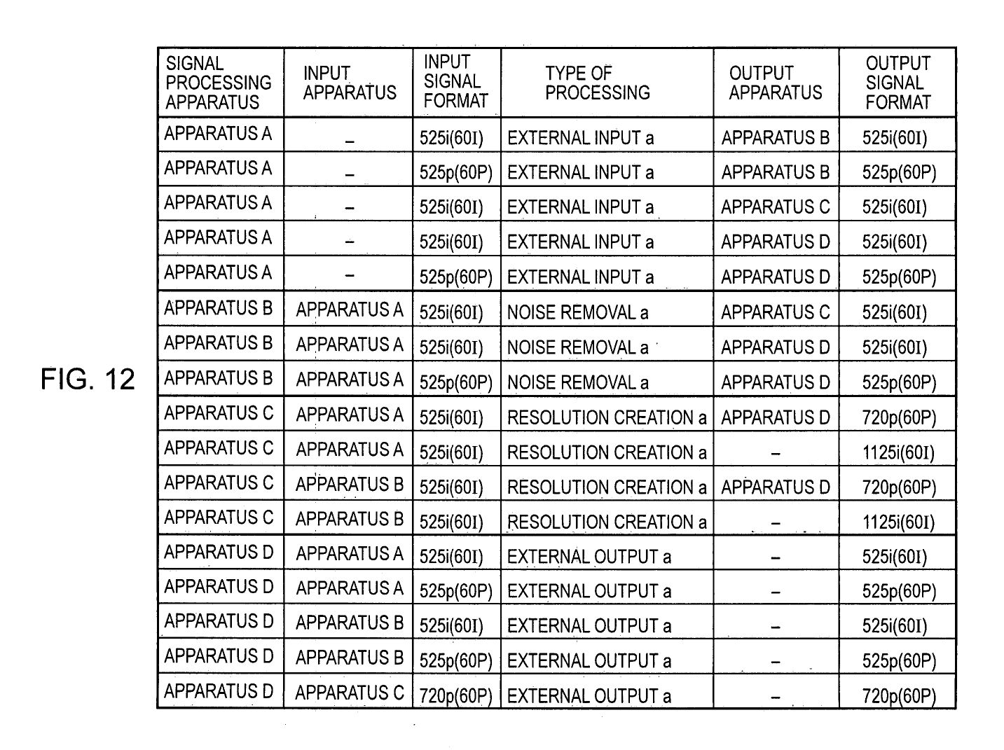

In step S14, the determination section 63 determines whether or not there is any other intermediate apparatus in the signal path table. In the signal path table shown in FIGS. 9 and 11, the signal processing apparatus C is also an intermediate apparatus. Thus, the process returns to step S12, and the selection section 65 selects the signal processing apparatus C as an intermediate apparatus. In step S13, the signal path table creation section 64 describes the signal processing apparatus D as an output apparatus of the signal processing apparatus C and describes the signal processing apparatus C as an input apparatus of the signal processing apparatus D, as shown in FIG. 12.

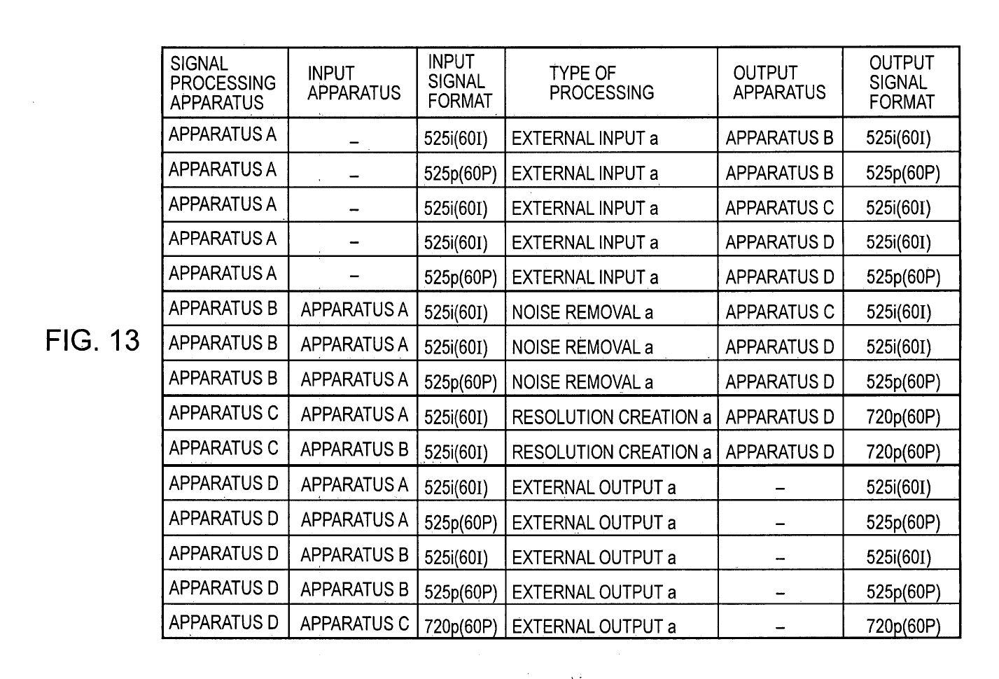

In step S14 again, the determination section 63 determines whether or not there is any other intermediate apparatus in the signal path table. In the signal path table shown in FIGS. 9 and 12, there is no other intermediate apparatus. Thus, in step S15, the determination section 63 determines whether or not there is any unestablished signal path. As shown in FIG. 12, no output apparatus is described for the second path from the top of the signal processing apparatus C, which is an intermediate apparatus. Similarly, no output apparatus is described for the fourth path from the top of the signal processing apparatus C. This means that these paths are not established. Thus, in step S16, the signal path table creation section 64 eliminates the unestablished signal paths. More specifically, the signal path table creation section 64 eliminates the second and fourth paths from the top of the signal processing apparatus C shown in FIG. 12. Thus, the signal path table is changed as shown in FIG. 13.

If the determination section 63 determines that there is no unestablished signal path in step S15, the process skips to step S17 since the processing in step S16 is unnecessary.

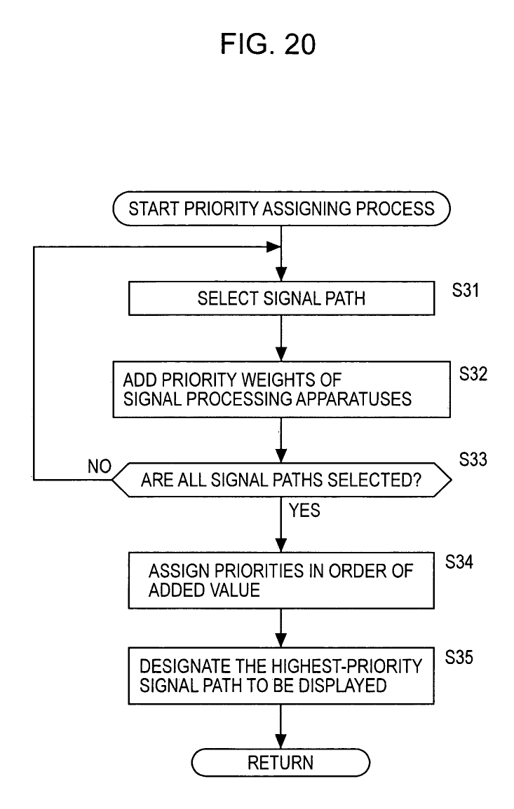

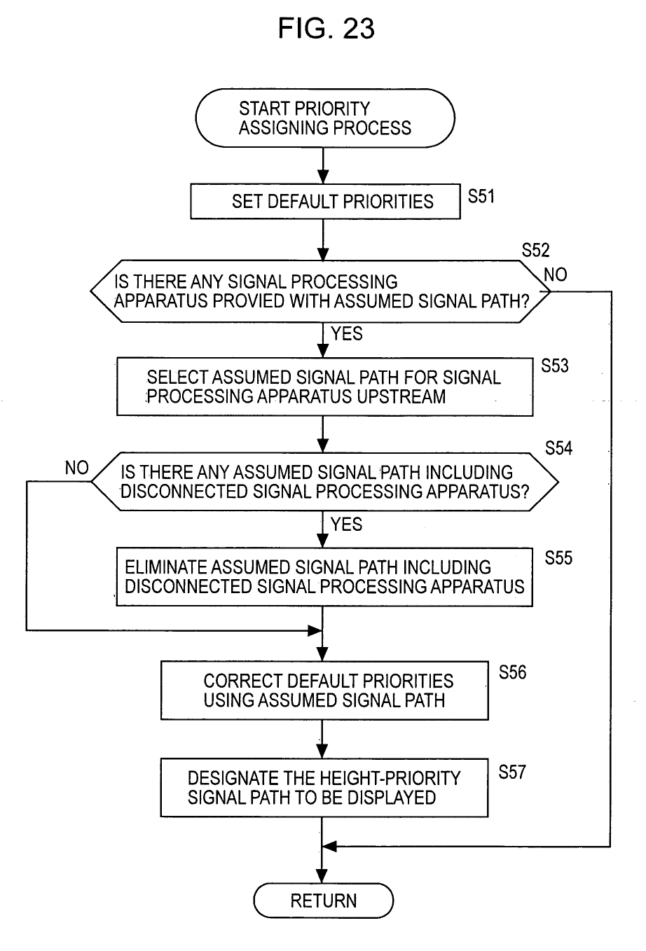

In step S17, the determination section 63 determines whether or not there is a plurality of signal paths. If there is a plurality of signal paths, priorities are assigned to the plurality of signal paths in order to select a signal path from among the plurality of signal paths in step S18. A process for assigning priorities will be descried below with reference to a flowchart in FIG. 20 or 23.

If the determination section 63 determines that there is not a plurality of signal paths in step S17, the processing for assigning priorities in step S18 is skipped.

In step S19, the display section 68 displays a signal path. More specifically, the display section 68 displays the signal path created in step S18 or steps S9, S13, and S16 on a monitor or the like to be presented to the user.

Then, in step S20, the parameter setting section 69 sets a parameter. A process for setting a parameter will be described below with reference to a flowchart in FIG. 28. Accordingly, parameters for signal processing apparatuses constituting the selected signal path are set.

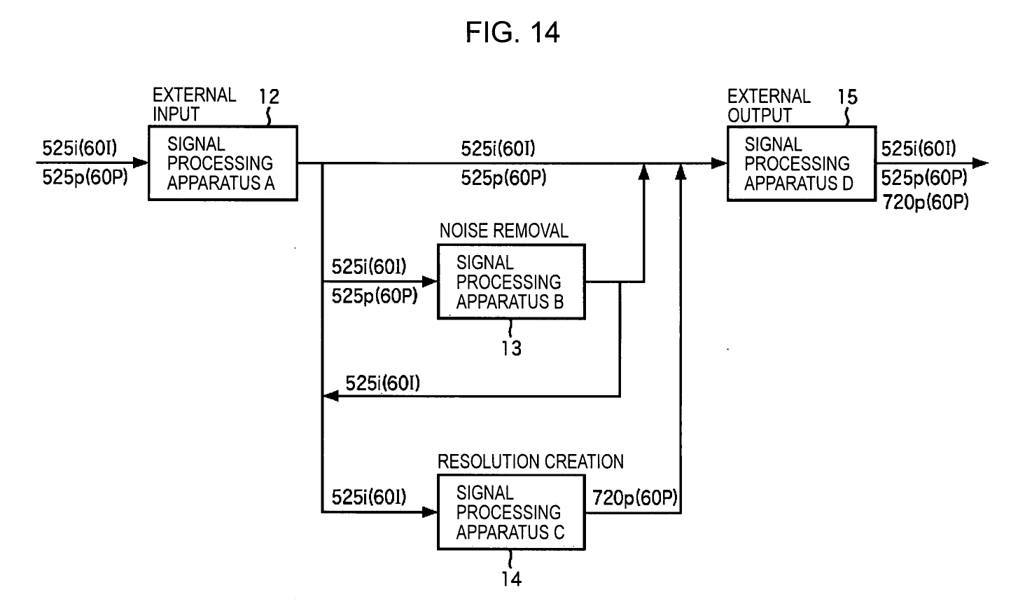

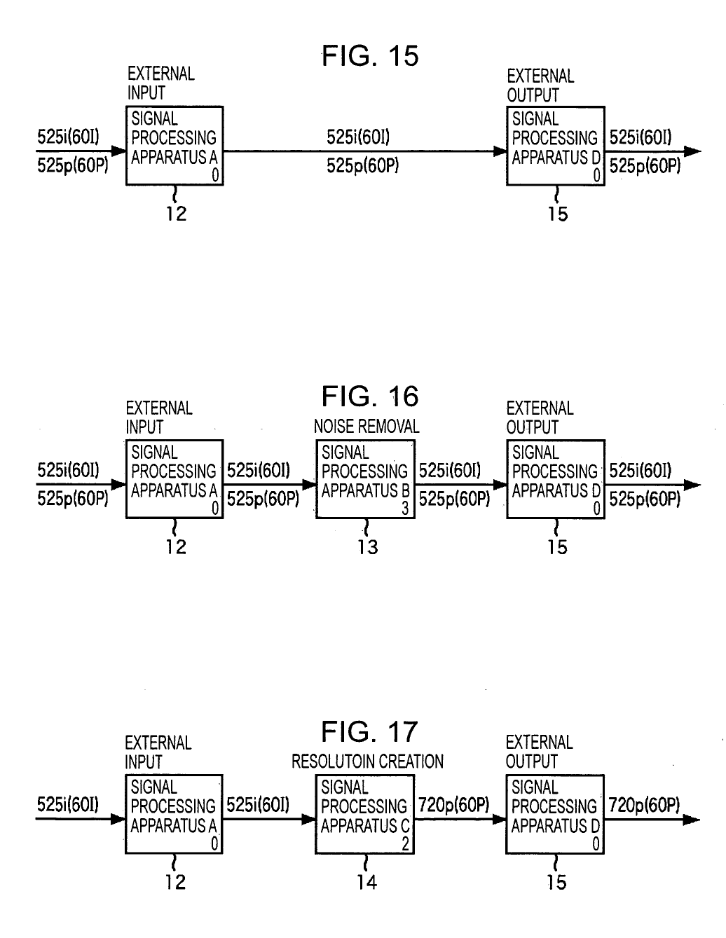

FIG. 14 illustrates the signal paths described in the signal path table shown in FIG. 13. The signal paths are four signal paths, as shown in expanded form in FIGS. 15 to 18.

In the signal path shown in FIG. 15, a signal is input to the signal processing apparatus A functioning as an external input apparatus in 525i(60I) or 525p(60P) input signal format, the signal processing apparatus A outputs the signal to the signal processing apparatus D functioning as an external output apparatus in the same format, and the signal processing apparatus D outputs the signal in the same output signal format. In other words, in this case, the input signal passes through as it is, and no processing is actually performed.

In the signal path shown in FIG. 16, the signal processing apparatuses A, B, and D are sequentially disposed. A signal is input to the signal processing apparatus A in the 525i(60I) or 525p(60P) input signal format, and the signal processing apparatus A supplies the input signal to the signal processing apparatus B functioning as an intermediate apparatus provided with a noise removal function. The signal processing apparatus B removes noise in the signal that is input in the 525i(60I) or 525p(60P) input signal format, and outputs the signal as an output signal to the signal processing apparatus D functioning as an external output apparatus in the corresponding output signal format. The signal processing apparatus D outputs the signal that is input in the 525i(60I) or 525p(60P) input signal format in the same format.

In the signal path shown in FIG. 17, the signal processing apparatuses A, C, and D are sequentially disposed. A signal is input to the signal processing apparatus A in the 525i(60I) input signal format, and the signal processing apparatus A supplies the input signal to the signal processing apparatus C functioning as an intermediate apparatus in the same format. The signal processing apparatus C creates resolution of the signal that is input in the 525i(60I) input signal format, and outputs the signal to the signal processing apparatus D functioning as an external output apparatus in 720p(60P) output signal format. The signal processing apparatus D outputs the signal that is input in the 720p(60P) input signal format to an external apparatus in the same format.

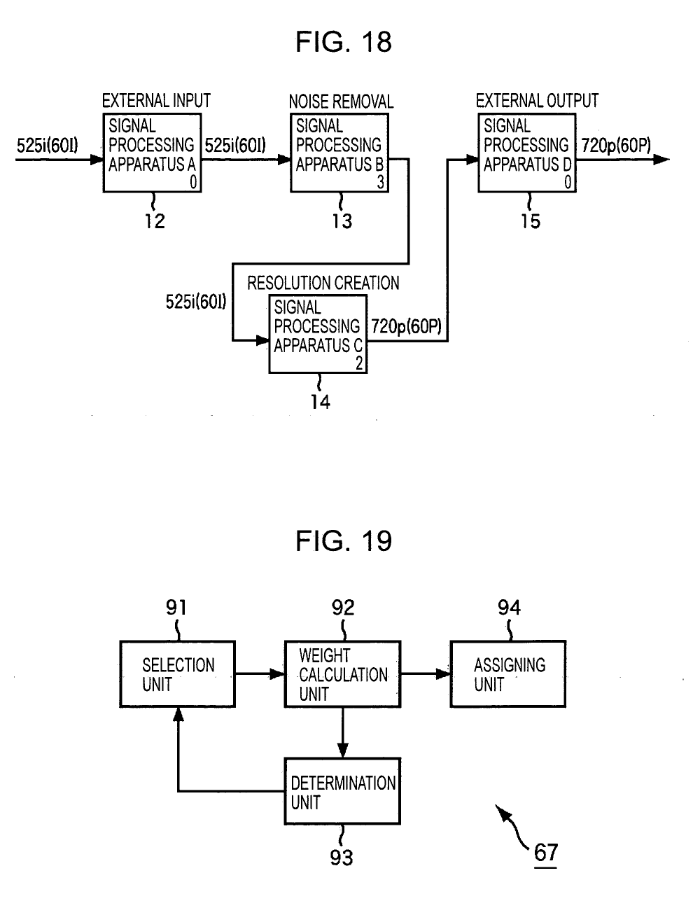

In the signal path shown in FIG. 18, the signal processing apparatuses A, B, and D are sequentially disposed. A signal is input to the signal processing apparatus A functioning as an external input apparatus in the 525i(60I) input signal format, and the signal processing apparatus A outputs the input signal to the signal processing apparatus B functioning as an intermediate apparatus in the same format. The signal processing apparatus B removes noise in the signal that is input in the 525i(60I) input signal format, and outputs the signal to the signal processing apparatus C functioning as an intermediate apparatus in the same signal format.

The signal processing apparatus C creates resolution of the signal that is input in the 525i(60I) input signal format, and outputs the signal to the signal processing apparatus D functioning as an external output apparatus in the 720p(60P) output signal format. The signal processing apparatus D outputs the signal that is input in the 720p(60P) input signal format to an external apparatus in the same format.

As described above, since there are four signal paths, the priority assigning section 67 designates a signal path in the processing for assigning priorities in step S18. Thus, the priority assigning section 67 has a functional structure shown in FIG. 19.

A selection unit 91 selects a signal path from among a plurality of signal paths. A weight calculation unit-92 calculates the weight of the signal path selected by the selection unit 91. A determination unit 93 determines whether or not weight calculation is performed for all the signal paths. If there is any signal path for which calculation is not performed, the determination unit 93 causes the selection unit 91 to select the signal path. An assigning unit 94 assigns priorities in accordance with the weight calculated by the weight calculation unit 92.

The priority assigning process will be described with reference to the flowchart shown in FIG. 20. In step S31, the selection unit 91 selects a signal path from among a plurality of signal paths. For example, the selection unit 91 selects the signal path shown in FIG. 15 from among the signal paths shown in FIGS. 15 to 18. In step S32, the weight calculation unit 92 adds the priority weights of signal processing apparatuses. More specifically, in this embodiment, weights 0, 3, 2, and 0 are provided in advance to the signal processing apparatuses A, B, C, and D, respectively. The weight and the signal processing apparatus ID are supplied from each signal processing apparatus to the system controller 11. The weight calculation unit 92 records the weights therein. For the signal path shown in FIG. 15, since the weight of each of the signal processing apparatuses A and D is 0, the added value is 0.

In step S33, the determination unit 93 determines whether or not all the signal paths are selected. Since all the signal paths are not selected in this case, the determination unit 93 causes the selection unit 91 to select another signal path in step S31. Thus, for example, the selection unit 91 selects the signal path shown in FIG. 16. In step S32, the weight calculation unit 92 adds the weights of apparatuses in the signal path shown in FIG. 16. In this case, the weights of the signal processing apparatuses A, B, and D are 0, 3, and 0, respectively. Thus, the added value is 3.

Subsequently, similar processing is sequentially performed. For the signal path shown in FIG. 17, the weights of the signal processing apparatuses A, C, and D are 0, 2, and 0, respectively. Thus, the added value is 2. For the signal path shown in FIG. 18, the weights of the signal processing apparatuses A, B, C, and D are 0, 3, 2, and 0, respectively. Thus, the added value is 5.

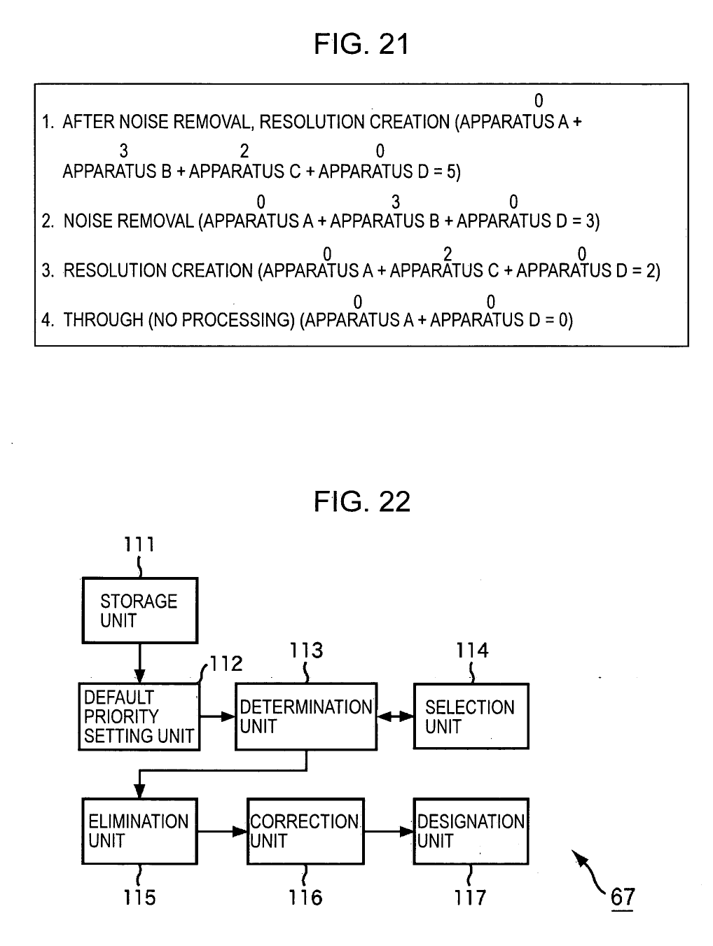

If the determination unit 93 determines that all the signal paths are selected in step S33, the assigning unit 94 assigns priorities in the order of added value in step S34. In other words, in this case, the added values of the weights of the four signal paths shown in FIGS. 15 to 18 are arranged in the order shown in FIG. 21. The added value of the weight of the signal path for performing resolution creation after noise removal shown in FIG. 18 is 5, which is the heaviest. The added value of the weight of the signal path for performing noise removal shown in FIG. 16 is 3, which is the second heaviest. The added value of the weight of the signal path for performing resolution creation shown in FIG. 17 is 2, which is the third heaviest. The added value of the weight of the signal path shown in FIG. 15 is 0, which is the lightest.

Thus, in this case, the priorities shown in FIG. 21 are assigned. Thus, in step S35, the assigning unit 94 designates the highest-priority signal path to be displayed. In the example shown in FIG. 21, the signal path for performing resolution creation after noise removal is selected. Thus, in this case, the signal path shown in FIG. 18 is displayed in the processing for displaying a signal path in step S19.

Although, in the priority assigning process, the priorities are assigned in accordance with the weight provided in advance to each signal processing apparatus, the weight may be determined in accordance with an assumed signal path that is assumed for each signal processing apparatus. In this case, the priority assigning section 67 has a structure, for example, shown in FIG. 22.

A storage unit 111 stores default priorities in advance. A default priority setting unit 112 sets the default priorities stored in the storage unit 111. A determination unit 113 determines whether or not there is any signal processing apparatus provided with an assumed signal path. A selection unit 114 selects an assumed signal path for a signal processing apparatus upstream.

An elimination unit 115 eliminates an assumed signal path including a signal processing apparatus that is not actually connected. A correction unit 116 corrects the default priorities set by the default priority setting unit 112 in accordance with the priorities selected by the selection unit 114. A designation unit 117 designates the highest-priority signal path.

A process for assigning priorities in accordance with an assumed signal path will be described with reference to the flowchart in FIG. 23.

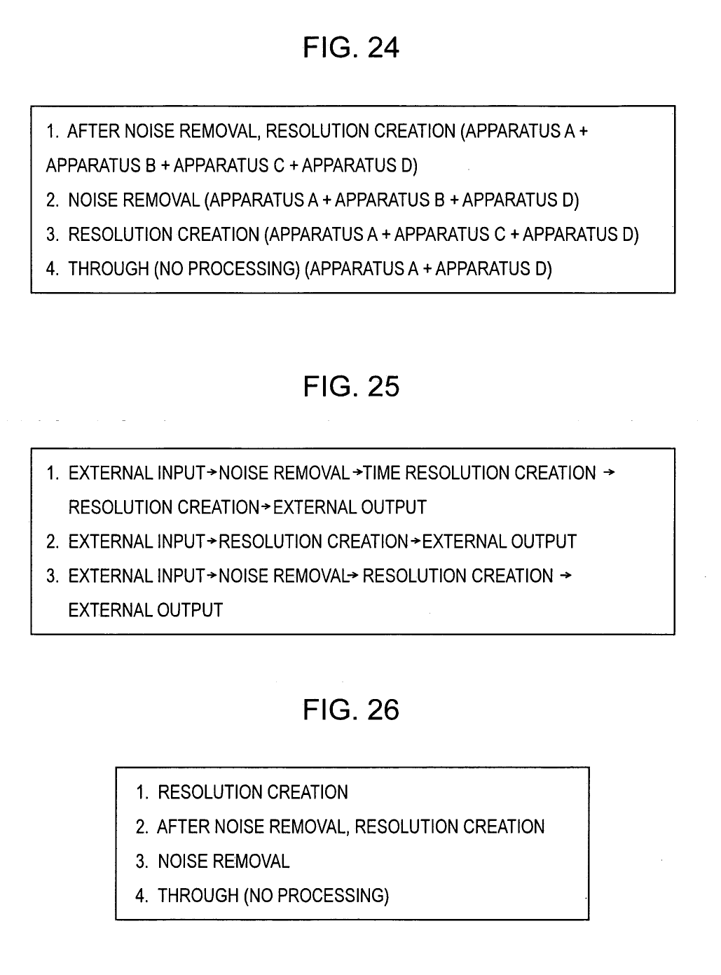

In step S51, the default priority setting unit 112 sets default priorities. More specifically, the default priorities stored in advance in the storage unit 111 are set as tentative priorities. For example, priorities determined by the process shown in FIG. 20 may be used as the default priorities. In this case, priorities shown in FIG. 24 are set as tentative priorities.

In other words, the priorities are assigned such that a signal path for performing resolution creation after noise removal is the highest priority, a signal path for performing noise removal is the second highest priority, a signal path for performing resolution creation is the third highest priority, and a signal path for causing a signal to simply pass through is the lowest priority.

In step S52, the determination unit 113 determines whether or not there is any signal processing apparatus provided with an assumed signal path. In other words, in this embodiment, the priorities of signal paths assumed when a signal processing apparatus is used are stored in advance in the signal processing apparatus. The assumed signal paths and signal processing apparatus ID are supplied to the system controller 11. For example, if assumed signal paths shown in FIG. 25 are provided to the signal processing apparatus C, the assumed signal paths are supplied to the system controller 11. In the example shown in FIG. 25, the priorities are assigned such that a signal path including external input, noise removal, time resolution creation, resolution creation, and external output in that order is the highest priority, a signal path including external input, resolution creation, and external output in that order is the second highest priority, and a signal path including external input, noise removal, resolution creation, and external output in that order is the third highest priority.

In step S53, the selection unit 114 selects an assumed signal path for a signal processing apparatus upstream. More specifically, the selection unit 114 selects an assumed signal path for a signal processing apparatus furthest upstream in the highest-priority signal path in the tentative priorities set in the processing in step S51. More specifically, since the priorities shown in FIG. 24 are set in step S51, the order of signal processing in the highest-priority signal path, which is the first signal path, is the signal processing apparatuses A, B, C, and D, in that order. Thus, the signal processing apparatus A is furthest upstream, and the signal processing apparatus D is furthest downstream. If an assumed signal path is provided to each of the signal processing apparatuses B and C, an assumed signal path for the signal processing apparatus B, which is upstream, is selected. In this case, since no assumed signal path is provided to the signal processing apparatus B, assumed signal paths for the signal processing apparatus C, which are shown in FIG. 25, are selected. Accordingly, a more suitable signal path can be set.

In step S54, the determination unit 113 determines whether or not there is any assumed signal path including a disconnected signal processing apparatus. In other words, the determination unit 113 determines whether or not there is any unperformable processing due to a disconnected signal processing apparatus in the assumed signal paths selected in the processing in step S53. In other words, the determination unit 113 determines whether or not another signal processing apparatus is required to be connected in order to perform the processing. If the processing cannot be performed unless another signal processing apparatus is connected, the assumed signal path cannot be realized. Thus, in step S55, the elimination unit 115 eliminates the assumed signal path including the disconnected signal processing apparatus. In the example shown in FIG. 25, the time resolution creation in the first signal path cannot be performed by either the signal processing apparatus A, B, C, or D. Thus, no signal processing apparatus that performs time resolution creation is connected. Thus, this assumed signal path is eliminated.

If the determination unit 113 determines that there is no assumed signal path including a disconnected signal processing apparatus in step S54, the process skips to step S56 since there is no assumed signal path to be eliminated in the processing in step S55.

In step S56, the correction unit 116 corrects the default priorities using the assumed signal paths. In this case, the priorities for the assumed signal paths have priority over the default priorities. Thus, the priorities shown in FIG. 24 set in the processing in step S51 are corrected using the assumed signal paths set in step S55, and priorities shown in FIG. 26 are created. In other words, in the priorities shown in FIG. 26, resolution creation, which is the third-priority processing in the priorities shown in FIG. 24, is the first-priority processing, and resolution creation after noise removal, which is the first-priority processing in the priorities shown in FIG. 24, is the second-priority processing. Thus, The third-priority processing in FIG. 24 is the highest-priority processing in FIG. 26.

In step S57, the designation unit 117 designates the highest-priority signal path to be displayed. More specifically, the designation unit 117 designates the first signal path shown in FIG. 26 for performing resolution creation, that is, the signal path shown in FIG. 17, as a signal path to be displayed.

Thus, in this case, the signal path shown in FIG. 17 is displayed in step S19 in FIG. 7.

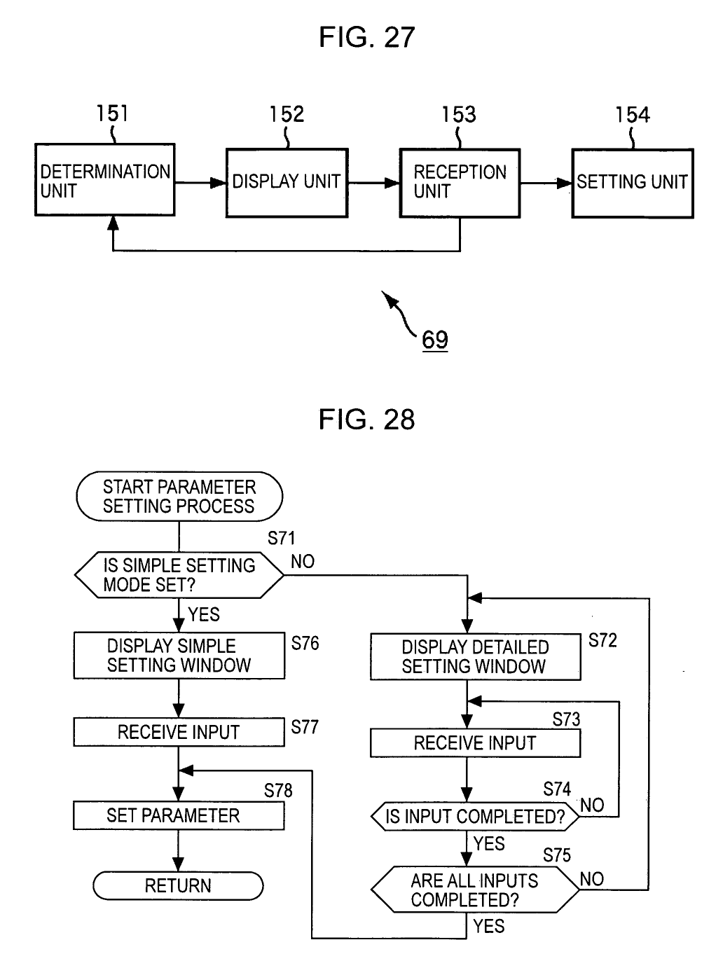

The parameter setting process in step S20 in FIG. 7 will be described. In order to perform the parameter setting process, the parameter setting section 69 shown in FIG. 5 has a functional structure, for example, shown in FIG. 27.

A determination unit 151 determines whether the mode designated by the user is a simple setting mode or a detailed setting mode. A display unit 152 displays a window, as a parameter setting input screen, corresponding to the mode determined by the determination unit 151. A reception unit 153 receives a parameter input by the user using the parameter input screen displayed by the display unit 152. A setting unit 154 sets the parameter received by the reception unit 153.

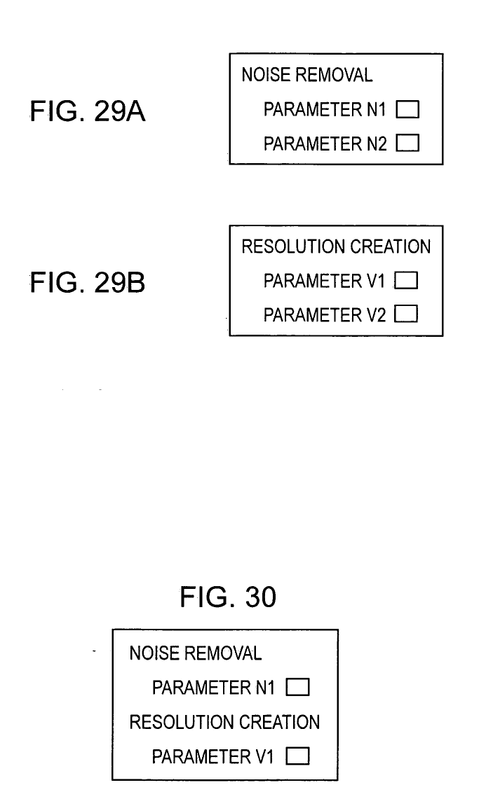

The parameter setting process is described next with reference to the flowchart shown in FIG. 28. In step S71, the determination unit 151 determines whether or not the mode currently set is a simple setting mode in accordance with an instruction given by the user. If the determination unit 151 determines that the simple setting mode is not set (a detailed setting mode is set), the display unit 152 causes a detailed setting window to be displayed on a monitor in step S72. Thus, for example, a parameter input screen for noise removal shown in FIG. 29A is displayed. The user inputs parameters N1 and N2 on the input screen as noise removal parameters.

When the user inputs the parameters, the reception unit 153 receives the input parameters in step S73. The reception unit 153 determines whether or not input is completed in step S74. If input is not completed, the process returns to step S73 to receive input again. If the reception unit 153 determines that input is completed, the determination unit 151 determines whether or not all inputs are completed in step S75. If all inputs are not completed, the determination unit 151 controls the display unit 152 to display a new parameter input screen, instead of the previous screen, in step S72. Thus, a parameter input screen shown in FIG. 29B is displayed. In this parameter input screen, parameters V1 and V2 are input as resolution creation parameters.

In step S73, the reception unit 153 receives input from the currently displayed parameter input screen, and repeats the receiving processing until the reception unit 153 determines that input is completed in step S74. If the reception unit 153 determines that input is completed, the determination unit 151 determines whether or not all inputs are completed in step S75 again. If the determination unit 151 determines that all inputs are completed, in step S78, the setting unit 154 sets the parameters received in step S73. Thus, the noise removal parameters N1 and N2 and the resolution creation parameters V1 and V2 set in the input screens shown in FIGS. 29A and 29B, respectively, are set. Thus, each of the signal processing apparatuses B and C performs noise removal or resolution creation using the corresponding parameters.

If the determination unit 151 determines that the current mode is a simple setting mode in step S71, the display unit 152 displays a simple setting window as a parameter input screen in step S76. FIG. 30 shows an example of the simple setting window. In the example shown in FIG. 30, only parameters N1 and V1 can be input as a noise removal parameter and a resolution creation parameter, respectively. In other words, since the simple setting mode is set, the user can easily set parameters. In other words, in the simple setting mode, the setting unit 154 automatically determines most appropriate values for the parameters N2 and V2 in accordance with the parameters N1 and V1 input by the user. Thus, although the user cannot adjust parameters in detail, input can be performed more easily.

In step S77, the reception unit 153 receives the parameters input on the window displayed in step S76. In step S78, the setting unit 154 sets the parameters received in step S77.

Accordingly, for the detailed setting mode, after completing input of the noise parameters on the parameter input screen shown in FIG. 29A, the parameter input screen is changed, and the parameter input screen for resolution creation shown in FIG. 29B is displayed. Thus, the user can set parameters in more detail.

In contrast, in the simple setting mode, an input screen is displayed only once. Thus, parameter setting can be performed more easily and more quickly.

If the voice delay controller 16 is connected, a delay-of processing time of an image signal and a delay of processing time of a voice signal can be synchronized with each other, in other words, so-called lip-sync processing can be performed, in accordance with the set signal path.

For example, the lengths of processing time of image signals of the signal processing apparatuses A to D shown in FIGS. 15 to 18 are set to 0, 1, 2, and 0, respectively. In this case, when the signal path shown in FIG. 15 is set, the amount of voice delay is set to 0. When the signal path shown in FIG. 16 is set, the amount of voice delay is set to 1. When the signal path shown in FIG. 17 is set, the amount of voice delay is set to 2. When the signal path shown in FIG. 18 is set, the amount of voice delay is set to 3. By setting as described above, each delay time may be controlled by the voice delay controller 16.

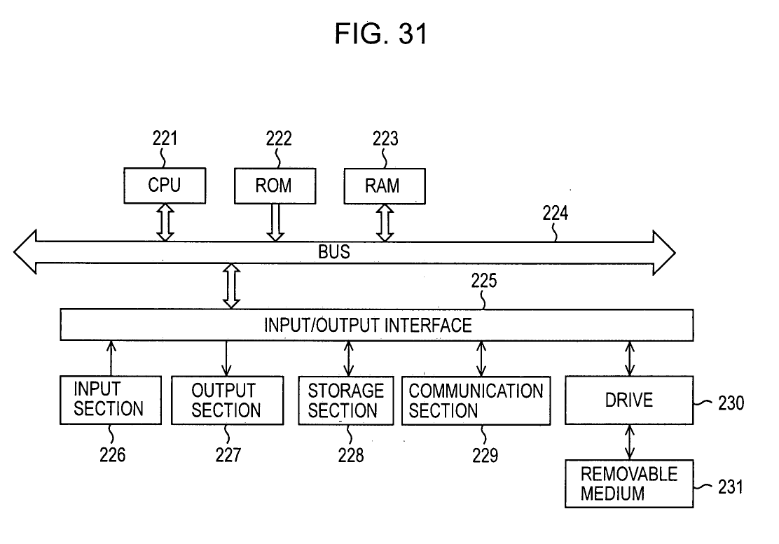

The foregoing series of processing may be performed by hardware or software. In this case, the system controller 11 includes a personal computer shown in FIG. 31.

Referring to FIG. 31, a central processing unit (CPU) 221 performs various types of processing in accordance with a program stored in a ROM 222 or a program loaded on a RAM 223 from a storage section 228. Data or the like necessary for the CPU 221 to perform various types of processing is also appropriately stored in the RAM 223.

The CPU 221, the ROM 222, and the RAM 223 are connected to each other via a bus 224. An input/output interface 225 is also connected to the bus 224.

The input/output interface 225 is connected to an input section 226 including a keyboard, a mouse, and the like, an output section 227 including a display, such as a cathode-ray tube (CRT) or a liquid crystal device (LCD), and a speaker, a storage section 228, such as a hard disk, and a communication section 229, such as a modem. The communication section 229 performs communication via a network including the Internet.

A drive 230 is connected to the input/output interface 225 according to need. A removable medium 231, such as a magnetic disk, an optical disk, a magneto-optical disk, or a semiconductor memory, is appropriately installed on the drive 230. A computer program read from the removable medium 231 is installed on the storage section 228 according to need.

When the series of foregoing processing is performed by software, a program constituting the software is installed via a network or a recording medium on a computer built in dedicated hardware or a general-purpose personal computer or the like capable of performing various functions by installing various programs.

As shown in FIG. 31, a recording medium not only includes the removable medium 231, such as a magnetic disk (including a flexible disk), an optical disk (including a compact disk-read only memory (CD-ROM) and a digital versatile disk (DVD)), a magneto-optical disk (including a MiniDisk (MD)), or a semiconductor memory, which records the program and is distributed in order to provide the program to a user independent of an apparatus main unit, but also includes the ROM 222 or the storage section 228, such as a hard disk, which records the program and is built in the apparatus main unit to be provided to the user.

In this embodiment, steps for a program recorded in a recording medium are not necessarily performed in chronological order in accordance with the written order. The steps may be performed in parallel or independently without being performed in chronological order.

In addition, in this embodiment, a system means the whole equipment including a plurality of apparatuses.

Another embodiment of the present invention will be described below.

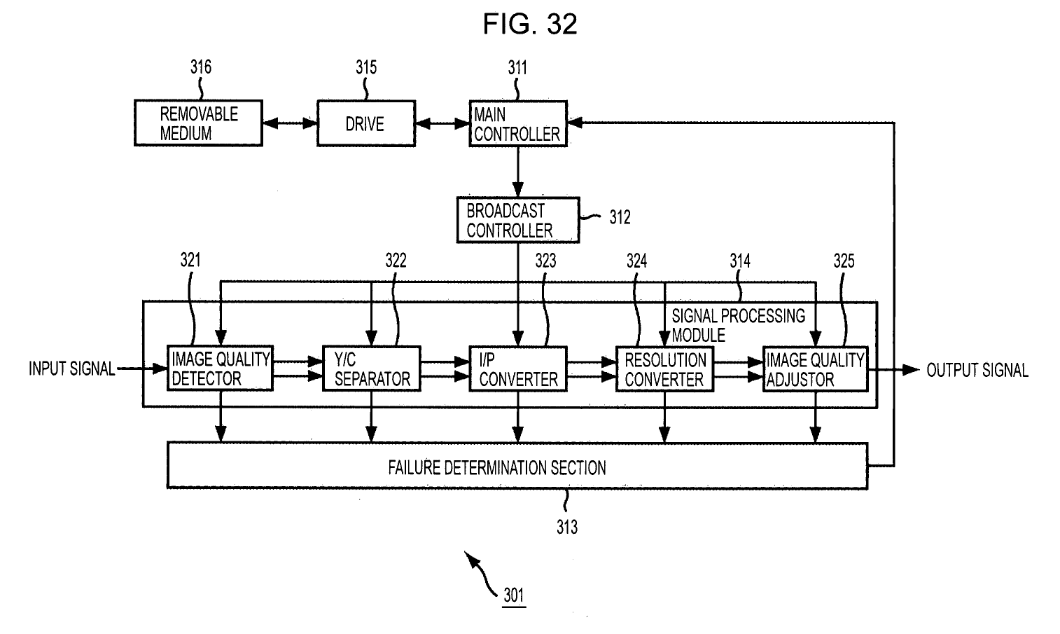

FIG. 32 shows an example of the structure of a main portion of a television receiver 301 according to this embodiment of the present invention. A main controller 311 performs basic maintenance and management of the system, such as management of a power source, initialization of a broadcast controller 312, and resetting of the system when a failure occurs. The broadcast controller 312 includes state machines for sections of a signal processing module 314. In order to control the operation of the sections, the broadcast controller 312 outputs a broadcast control signal to each of the sections of the signal processing module 314 in accordance with an instruction from the main controller 311 based on a user operation.

A failure determination section 313 receives an error signal from each section of the signal processing module 314, determines which section has a failure, and reports the determination result to the main controller 311.

A broadcast control signal may be output via radio communication or wire communication. In addition, a broadcast control signal may be transmitted via a network.

The signal processing module 314 includes an image quality detector 321, a Y/C separator 322, an I/P converter 323, a resolution converter 324, and an image quality adjustor 325.

The image quality detector 321 detects the field intensity of an external input signal and detects whether or not the input video signal is in 2-3 pull-down format. The Y/C separator 322 separates the video signal supplied from the image quality detector 321 into a luminance signal Y and a chrominance signal C. The Y/C separator 322 also converts a 4:2:2 YUV signal into a 4:4:4 YUV signal. The Y/C separator 322 may have any structure as long as it has a function to separate a luminance signal from a chrominance signal. For example, the Y/C separator 322 may have a structure described in Japanese Patent No. 3387170.

The I/P converter 323 converts the video signal in interlace format supplied from the Y/C separator 322 into a signal in progressive format. The I/P converter 323 may have any structure. For example, the I/P converter 323 may have a structure described in Japanese Unexamined Patent Application Publication No. 2003-319349.

The resolution converter 324 changes the resolution of the video signal supplied from the I/P converter 323. For example, the resolution converter 324 converts an input standard definition (SD) signal into a high definition (HD) signal. The resolution converter 324 may have any structure. For example, the resolution converter 324 may have a structure described in Japanese Unexamined Patent Application Publication No. 2002-218414.

The image quality adjustor 325 adjusts the image quality of the video signal supplied from the resolution converter 324. More specifically, the image quality adjustor 325 adjusts the level of the video signal to be suitable for a display apparatus, such as an LCD, a CRT, or a plasma display.

Furthermore, each section of the signal processing module 314 may be a chip having basically the same structure. A function of each section of the signal processing module 314 may be changed in accordance with a control signal. For example, each chip may have a structure described in PCT Application No. WO96/07987.

A drive 315 for driving a removable medium 316 is connected to the main controller 311 according to need.

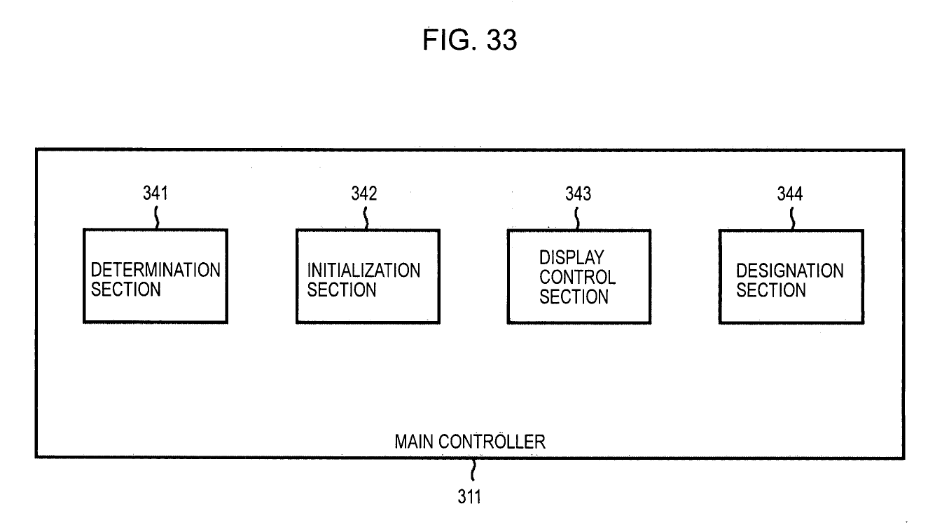

Controlling the signal processing module 314 by the main controller 311 will be described below. In order to control the signal processing module 314, the main controller 311 has a functional structure including a determination section 341, an initialization section 342, a display control section 343, and a designation section 344, as shown in FIG. 33.

The determination section 341 makes various determinations, such as whether or not a failure report from the failure determination section 313 is received and whether or not an instruction to terminate a process is given. The initialization section 342 initializes the broadcast controller 312. The display control section 343 displays a predetermined message for the user. The designation section 344 outputs various instructions to each section of the signal processing module 314 via the broadcast controller 312.

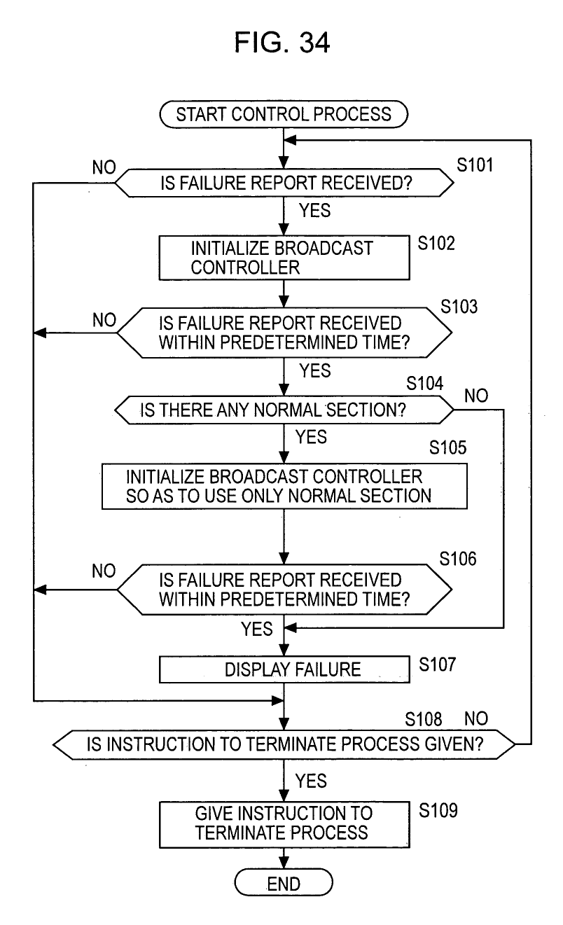

A control process is described next with reference to a flowchart in FIG. 34.

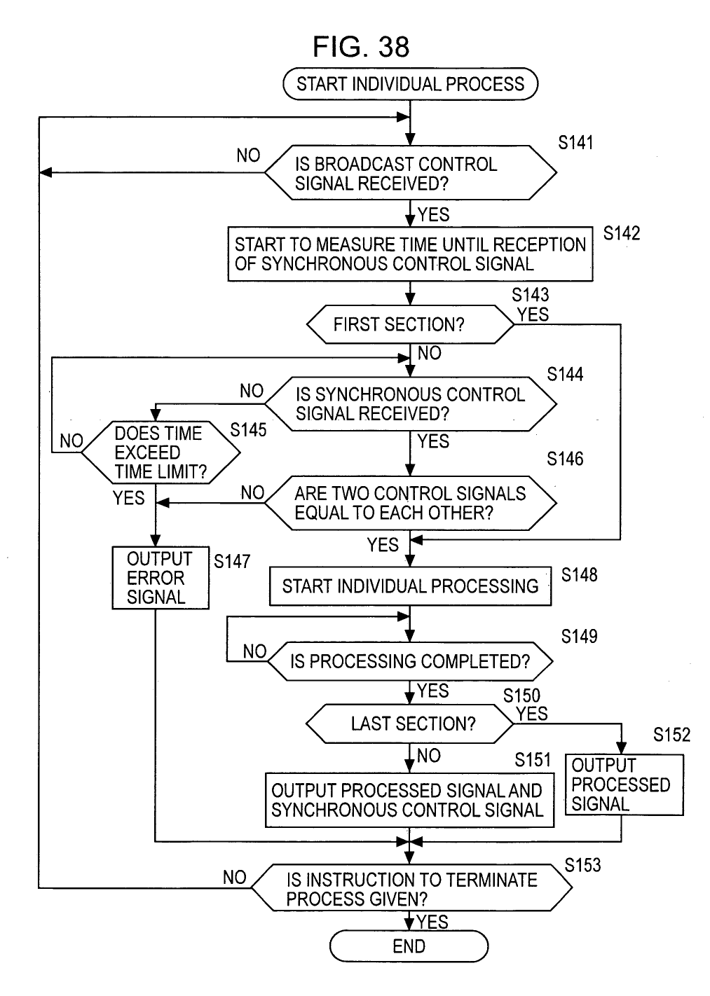

In step S101, the determination section 341 determines whether or not a failure report is received from each section of the signal processing module 314. If no failure report is received from the signal processing module 314, the initialization section 342 initializes the broadcast controller 312 in step S102. For example, the initialization section 342 initializes each section such that the signal processing module 314 generates a progressive HD signal from an input interlace SD signal. Thus, the initialization section 342 controls the broadcast controller 312 to output a broadcast control signal for converting an interlace SD signal into a progressive HD signal to the image quality detector 321, the Y/C separator 322, the I/P converter 323, the resolution converter 324, and the image quality adjustor 325 of the signal processing module 314. The sections of the signal processing module 314 perform corresponding processing in accordance with the control signal. This processing will be described below with reference to a flowchart in FIG. 38.

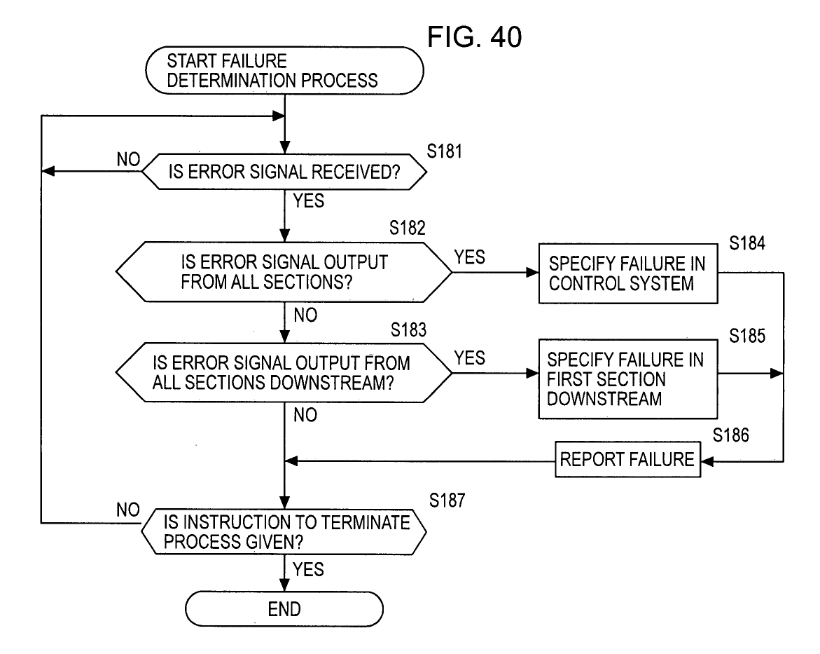

The sections of the signal processing module 314 are cascade-connected to each other. A signal input from the previous stage is output to the subsequent stage. At this time, a processed signal and a synchronous control signal are output from the previous stage to the subsequent stage. If a section does not receive a synchronous control signal from the previous stage within a predetermined time after receiving a broadcast control signal, the section outputs an error signal to the failure determination section 313 (in step S147 in FIG. 38). When receiving an error signal from a section of the signal processing module 314, the failure determination section 313 determines the failure section and reports the determination result to the main controller 311 (in step S186 in FIG. 40).

In step S103, the determination section 341 determines whether or not a failure report is received within a predetermined time, which is set in advance, after performing initialization (after outputting a broadcast control signal). The predetermined time is set to be slightly longer than the time required for processing from sequentially outputting a signal processed by the image quality detector 321 to the subsequent stage to outputting the signal processed by the image quality adjustor 325 when each section of the signal processing module 314 operates normally. Thus, if no failure report is received within the predetermined time, it is determined that each section of the signal processing module 314 operates normally.

If the determination section 341 determines that a failure report is received within the predetermined time in step S103, the determination section 341 determines whether or not there is any normal section in which no failure occurs in step S104. If there is any normal section, the initialization section 342 initializes the broadcast controller 312 so as to use only the normal section in step S105. The broadcast controller 312 outputs a broadcast control signal to each section of the signal processing module 314 in accordance with the initialization.

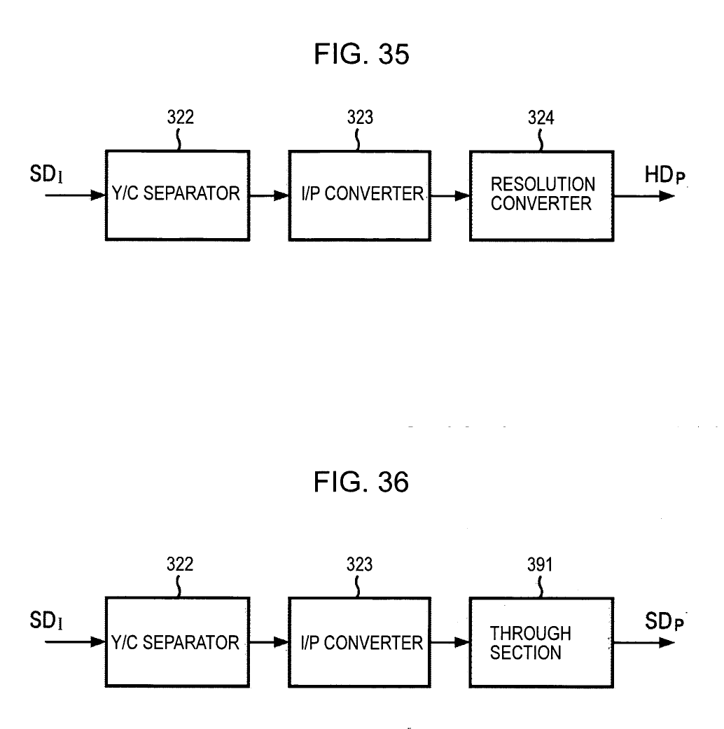

For example, first, the initialization section 342 operates the Y/C separator 322, the I/P converter 323, and the resolution converter 324, and gives an instruction to the Y/C separator 322, the I/P converter 323, and the resolution converter 324 to convert an input interlace SD signal into a progressive HD signal, as shown in FIG. 35. However, if a failure occurs in the resolution converter 324 and resolution conversion cannot be performed, initialization is performed such that an interlace SD signal is converted into a progressive SD signal and the converted progressive SD signal is output. In this case, as shown in FIG. 36, although the Y/C separator 322 and the I/P converter 323 perform processing similar to that performed when a control signal for converting an SD signal into an HD signal is input, the resolution converter 324 functions as a through section 391 that simply causes an input signal to pass through and outputs the signal as it is, instead of performing resolution conversion. This processing prevents at least a situation in which a user cannot view an image. Then, in step S106, the determination section 341 determines whether or not a failure report is received within a predetermined time set in advance after performing the initialization processing in step S105. If a failure report is received, normal operation cannot be ensured. Thus, in step S107, the display control section 343 displays that a failure occurs. More specifically, a message, such as “Failure occurred.”, is presented to the user. The user looks at this message, and repairs the failure if necessary.

In step S108, the determination section 341 determines whether or not an instruction to terminate the process is given by the user. If an instruction to terminate the process is not given, the process returns to step S101 to repeat the subsequent processing.

If the determination section 341 determines that no failure report is received in step S101 or if the determination section 341 determines that no failure report is received within the predetermined time in step S103 or S106, the process proceeds to step S108 to determine whether or not an instruction to terminate the process is given. If an instruction to terminate the process is not given, the process returns to step S101, and the subsequent processing is repeated.

If the determination section 341 determines that an instruction to terminate the process is given by the user in step S108, the designation section 344 controls the broadcast controller 312 to output a broadcast control signal indicating an instruction to terminate the process to each section of the signal processing module 314 in step S109. Each section of the signal processing module 314 terminates the process in accordance with the control signal.

An individual process performed by each section of the signal processing module 314 will be described below. Since all the sections perform processing in accordance with basically the same flow, the process performed by the Y/C separator 322 will be described below as an example.

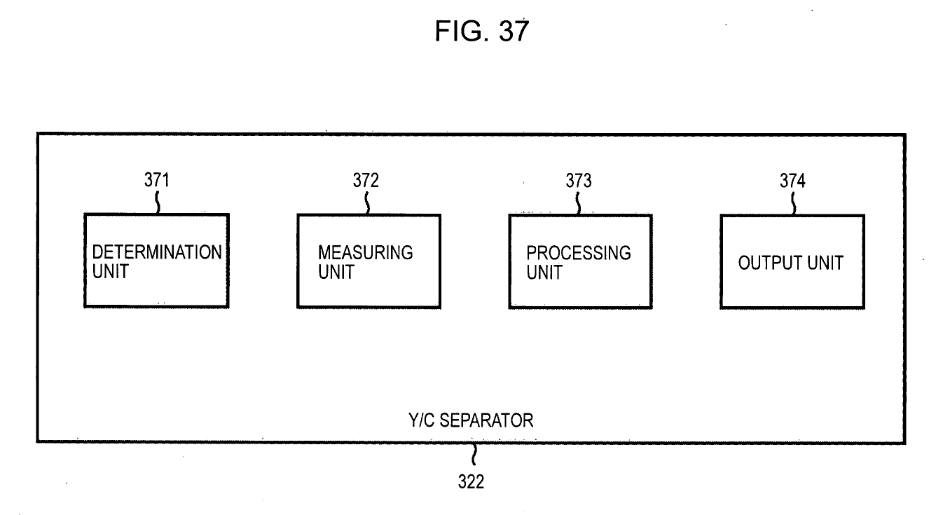

In this case, the Y/C separator 322 includes a determination unit 371, a measuring unit 372, a processing unit 373, and an output unit 374, as shown in FIG. 37. Although not illustrated, each of the image quality detector 321, the I/P converter 323, the resolution converter 324, and the image quality adjustor 325 has a similar structure to that of the Y/C separator 322.

The determination unit 371 determines whether or not a control signal is received, whether or not the received broadcast control signal is equal to a synchronous control signal, whether or not processing ends, whether or not the section is the last section, and whether or not an instruction to terminate the process is given. The measuring unit 372 keeps time, and measures the time from reception of a broadcast control signal to reception of a synchronous control signal. The processing unit 373 performs unique processing. In this example, the processing unit 373 of the Y/C separator 322 separates a luminance signal from a chrominance signal. The output unit 374 outputs the processed signal processed by the processing unit 373 and a synchronous control signal having substantially the same content as the received broadcast control signal to the subsequent stage (in this case, to the I/P converter 323).

The individual process performed by the Y/C separator 322 is described next with reference to the flowchart in FIG. 38. In step S141, the determination unit 371 determines whether or not a broadcast control signal is received. The broadcast control signal is output in the processing in step S102 or S105 in FIG. 34. If a broadcast control signal is not received, the processing in step S141 is repeated until a broadcast control signal is received.

If the determination unit 371 determines that a broadcast control signal is received in step S141, the measuring unit 372 starts to measure the time until a synchronous control signal is received in step S142. In other words, since the image quality detector 321 is disposed in the previous stage of the Y/C separator 322, the image quality detector 321 completes processing, and then outputs a processed signal and a synchronous signal to the Y/C separator 322 (in the processing performed by the image quality detector 321 in step S151). The measuring unit 372 measures the time until the synchronous control signal is received.

In step S143, the determination unit 371 determines whether or not the Y/C separator 322 is the first section in the signal processing module 314. A determination as to whether or not a section is the first section in step S143 and a determination as to whether or not a section is the last section in step S150 are set and stored in advance in each section. Alternatively, the time from reception of a broadcast control signal to reception of a control signal and a processed signal from the previous stage may be stored in seconds or in the form of the number of frames or the number of fields of a video signal, so that each section can determine its own location in accordance with the time.

Since the Y/C separator 322 is not the first section, the determination unit 371 determines whether or not a synchronous control signal is received in step S144. If a section is not the first section, a processed signal and a synchronous control signal are supplied from a section in the previous stage (in step S151). Thus, if a synchronous control signal is not received, the measuring unit 372 determines whether or not the time measured in step S142 exceeds a time limit set in advance in step S145. The same time limit may be used for all the sections. Alternatively, the time limit may be set in accordance with the cascade connection order of the sections.

If the time measured in step S142 does not exceed the time limit, the process returns to step S144 to repeat the processing in steps S144 and S145 until a synchronous control signal is received. If the determination unit 371 determines that a synchronous control signal is received from the previous stage within the time limit, the determination unit 371 determines whether or not two control signals are equal to each other in step S146. In other words, in step S151, each section outputs a control signal that has the same content as the broadcast control signal received from the broadcast controller 312 as a synchronous control signal to the subsequent section. Thus, the broadcast control signal and the synchronous control signal are substantially equal to each other. If the two control signals are equal to each other, the processing unit 373 starts individual processing in step S148. In this case, the processing unit 373 of the Y/C separator 322 separates a video signal input from the image quality detector 321 in the previous stage into a luminance signal and a chrominance signal.

In step S149, the determination unit 371 determines whether or not the processing ends in step S149, and waits for termination of the processing. If the processing ends, the determination unit 371 determines whether or not the Y/C separator 322 is the last section in the signal processing module 314 in step S150. Since the Y/C separator 322 is not the last section, the output unit 374 outputs a processed signal and a synchronous control signal in step S151. In other words, the output unit 374 outputs to the I/P converter 323 in the subsequent stage the luminance signal and the chrominance signal separated by the processing unit 373, together with the synchronous control signal that has substantially the same content as the broadcast control signal received in step S141.

If a section is the last section in the signal processing module 314, there is no cascade-connected processing section controlled by the broadcast controller 312 in the subsequent stage. In the example shown in FIG. 32, the image quality adjustor 325 is the last section in the signal processing module 314. In this case, since the output unit 374 of the image quality adjustor 325 does not need to output a synchronous control signal, only a processed signal is output to the subsequent stage in step S152.

If the determination unit 371 determines that the time from reception of a broadcast control signal to reception of a synchronous control signal exceeds the time limit in step S145 or if the determination unit 371 determines that two control signals are not equal to each other in step S146, the output unit 374 outputs an error signal to the failure determination section 313 in step S147. The failure determination section 313 determines which section in the signal processing module 314 has a failure in accordance with the error signal. (A failure determination process performed by the failure determination section 313 will be described below with reference to a flowchart in FIG. 40.) After the processing in steps S147, S151, and S152, the determination unit 371 determines whether or not an instruction to terminate the process is given in step S153. If the determination unit 371 determines that an instruction to terminate the process is not given by the user, the process returns to step S141, and the subsequent processing is repeated. If the determination unit 371 determines that an instruction to terminate the process is given by the user in step S153, the process ends.

The instruction to terminate the process is given in accordance with a broadcast control signal.

As described above, the image quality detector 321 detects an image quality of an input SD signal, and detects the field intensity, noise, and a 2-3 pull-down signal. Then, the image quality detector 321 outputs detection results and the input signal to the Y/C separator 322. The Y/C separator 322 separates the input video signal into a luminance signal and a chrominance signal. The separated luminance signal and chrominance signal are supplied to the I/P converter 323. The I/P converter 323 converts the input luminance signal and chrominance signal in interlace format into a luminance signal and a chrominance signal in progressive format. The resolution converter 324 converts the progressive luminance and chrominance signals, which are SD signals, input from the I/P converter 323 into HD signals by increasing the pixel density.

The image quality adjustor 325 adjusts the levels of the HD luminance and chrominance signals supplied from the resolution converter 324 to be most suitable for a display apparatus, which is not shown. Then, the image quality adjustor 325 outputs the adjusted HD luminance and chrominance signals to the display apparatus.

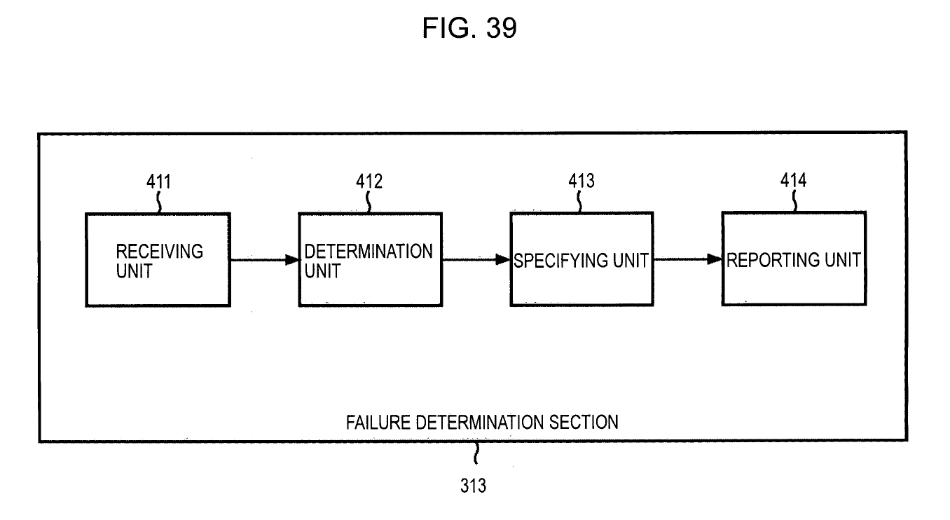

The failure determination process performed by the failure determination section 313 is described next. As shown in FIG. 39, the failure determination section 313 includes a receiving unit 411, a determination unit 412, a specifying unit 413, and a reporting unit 414.

The receiving unit 411 receives an error signal output from a section of the signal processing module 314 in step S147 in FIG. 38. The determination unit 412 determines which section of the signal processing module 314 has a failure in accordance with the error signal received by the receiving unit 411. The specifying unit 413 specifies the failure section of the signal processing module 314 in accordance with the determination result by the determination unit 412. The reporting unit 414 reports to the main controller 311 that the failure occurs in the section specified by the specifying unit 413.

The failure determination process performed by the failure determination section 313 is described next with reference to the flowchart in FIG. 40. In step S181, the receiving unit 411 receives an error signal output from the image quality detector 321, the Y/C separator 322, the I/P converter 323, the resolution converter 324, or the image quality adjustor 325 of the signal processing module 314, and the determination unit 412 determines whether or not the error signal is received in accordance with an output from the receiving unit 411. If an error signal is received, the determination unit 412 determines whether or not the error signal is output from all sections in step S182 or determines whether or not the error signal is output from all sections downstream in step S183.

If the determination unit 412 determines that the error signal is output from all sections in step S182, the specifying unit 413 specifies that a failure occurs in a control system in step S184. In other words, in this case, since an error signal is output from each of the image quality detector 321, the Y/C separator 322, the I/P converter 323, the resolution converter 324, and the image quality adjustor 325 shown in FIG. 32, a broadcast control signal output from the broadcast controller 312 may not be effectively received by each section. Thus, in this case, it is determined that a failure occurs in the whole control system.

If the determination unit 412 determines that the error signal is output from all sections downstream in step S183, the specifying unit 413 specifies that a failure occurs in the first section downstream in step S185. For example, if the image quality detector 321 does not output an error signal but an error signal is detected from each of the Y/C separator 322, the I/P converter 323, the resolution converter 324, and the image quality adjustor 325 downstream of the image quality detector 321, the specifying unit 413 specifies that a failure occurs in the Y/C separator 322, which is the first section of the four sections downstream of the image quality detector 321, and that an error signal is thus output from each of the I/P converter 323, the resolution converter 324, and the image quality adjustor 325 downstream of the Y/C separator 322 since the Y/C separator 322 does not output a signal to the subsequent stage.

Similarly, if each of the image quality detector 321 and the Y/C separator 322 does not output an error signal but each of the I/P converter 323, the resolution converter 324, and the image quality adjustor 325, which are downstream of the image quality detector 321 and the Y/C separator 322, outputs an error signal, the specifying unit 413 specifies that a failure occurs in the I/P converter 323, which is the first section of the three sections downstream. If each of the image quality detector 321, the Y/C separator 322, and the I/P converter 323 does not output an error signal but each of the resolution converter 324 and the image quality adjustor 325, which are downstream of the image quality detector 321, the Y/C separator 322, and the I/P converter 323, outputs an error signal, the specifying unit 413 specifies that a failure occurs in the resolution converter 324, which is the first section of the two sections downstream. If each of the image quality detector 321, the Y/C separator 322, the I/P converter 323, and the resolution converter 324 does not output an error signal and only the image quality adjustor 325, which is furthest downstream, outputs an error signal, the specifying unit 413 specifies that a failure occurs in the image quality adjustor 325.

If the specifying unit 413 specifies the failure section in step S184 or S185, the reporting-unit 414 reports the failure in step S186. More specifically, if the specifying unit 413 specifies that a failure occurs in the control system, the reporting unit 414 reports to the main controller 311 that the failure occurs in the control system. Similarly, if the specifying unit 413 specifies that a failure occurs in the first section downstream, information specifying the section is reported to the main controller 311. More specifically, if the specifying unit 413 specifies that a failure occurs in the Y/C separator 322, the reporting unit 414 reports to the main controller 311 that the failure occurs in the Y/C separator 322.

After the determination unit 412 determines that no error signal is output from each section in steps S182 and S183 and after a failure is reported in step S186, the process proceeds to step S187. In step S187, the determination unit 412 determines whether or not an instruction to terminate the process is given. If an instruction to terminate the process is not given, the process returns to step S181, and the subsequent processing is repeated. If the determination unit 412 determines that an instruction to terminate the process is given in step S187, the process ends.

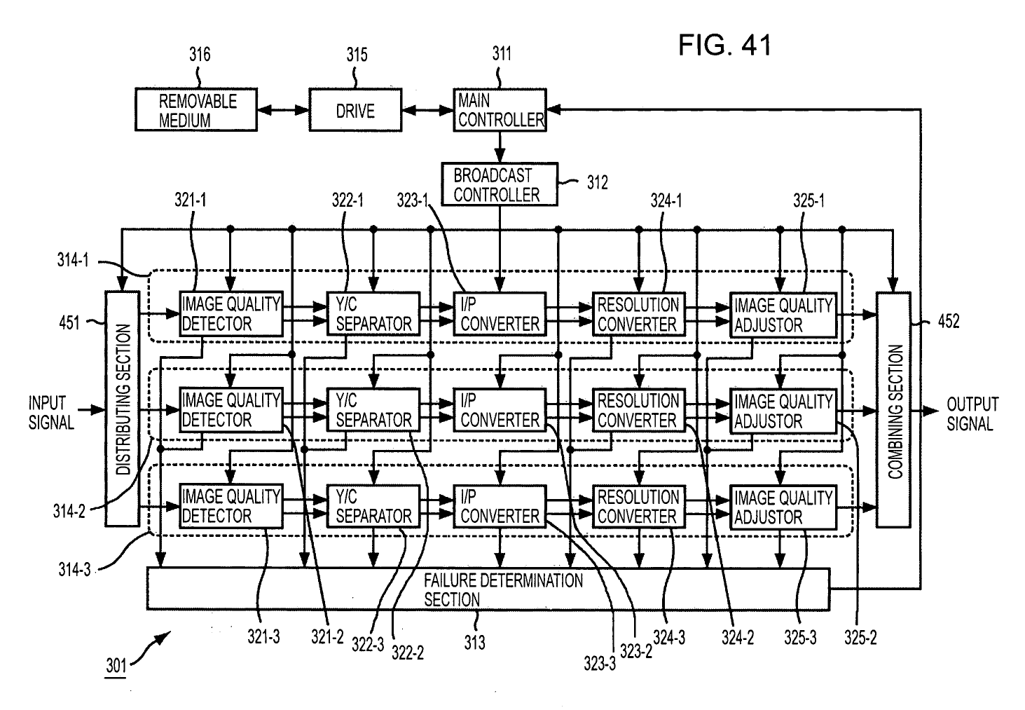

FIG. 41 shows another example of the structure of the television receiver 301. In this example, three signal processing modules 314-1, 314-2, and 314-3 are provided. In other words, the signal processing module 314-1 includes an image quality detector 321-1, a Y/C separator 322-1, an I/P converter 323-1, a resolution converter 324-1, and an image quality adjustor 325-1. The signal processing module 314-2 includes an image quality detector 321-2, a Y/C separator 322-2, an I/P converter 323-2, a resolution converter 324-2, and an image quality adjustor 325-2. The signal processing module 314-3 includes an image quality detector 321-3, a Y/C separator 322-3, an I/P converter 323-3, a resolution converter 324-3, and an image quality adjustor 325-3. The signal processing modules 314-1, 314-2, and 314-3 are disposed in parallel to each other. A distributing section 451 divides an input signal into three and supplies the divided signals to the corresponding signal processing modules 314-1 to 314-3. A combining section 452 combines signals output from the signal processing modules 314-1 to 314-3, and outputs the combined signal as an output signal. The other structure is similar to that shown in FIG. 32.

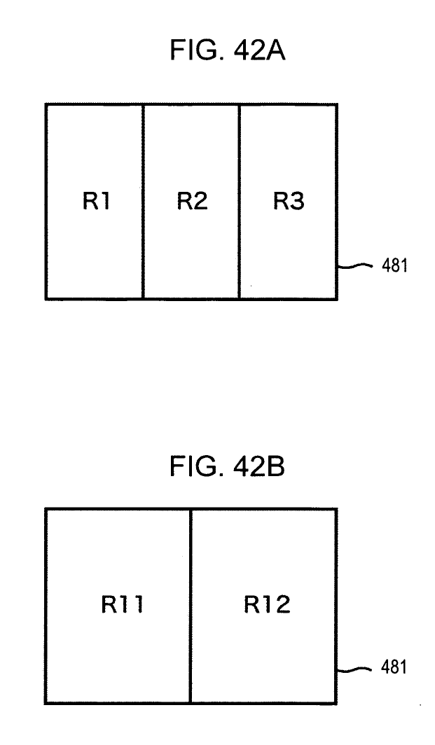

In other words, in this embodiment, the distributing section 451 divides a frame (or field) 481 of an input signal into three equal regions, that is, a left region R1, a central region R2, and a right region R3, in the vertical direction, as shown in FIG. 42A. A signal in the left region R1 is supplied to the signal processing module 314-1, a signal in the central region R2 is supplied to the signal processing module 314-2, and a signal in the right region R3 is supplied to the signal processing module 314-3.

Basically, each of the signal processing modules 314-1 to 314-3 performs processing similar to that performed by the sections from the image quality detector 321 to the image quality adjustor 325 of the signal processing module 314 shown in FIG. 32. However, the sections from the image quality detector 321-1 to the image quality adjustor 325-1 perform processing only for a signal in the left region R1, the sections from the image quality detector 321-2 to the image quality adjustor 325-2 perform processing only for a signal in the central region R2, and the sections from the image quality detector 321-3 to the image quality adjustor 325-3 perform processing only for a signal in the right region R3. Accordingly, the three signal processing modules 314-1 to 314-3 process video signals in parallel. Thus, processing can be performed more quickly.

The frame 481 may be divided into three in the horizontal direction, instead of being divided into three in the vertical direction, as shown in FIG. 42A. However, if the frame 481 is divided into three in the horizontal direction, a one-third-frame time delay occurs in signals processed by the signal processing modules 314-1 to 314-3. Thus, a longer waiting time is required until a signal in the next frame is input to the signal processing modules 314-1 to 314-3. Thus, when the frame 481 is divided into three in the vertical direction, as shown in FIG. 42A, a shorter waiting time, such as only one-third time of a line, is required for the signal processing module 314.

Control processing, individual processing, and failure determination processing performed by the television receiver 301 shown in FIG. 41 are basically similar to those described above. In this case, however, if a failure occurs in any of the sections from the image quality detector 321-3 to the image quality adjustor 325-3 of the signal processing module 314-3 from among the three signal processing modules 314-1 to 314-3, only the signal processing modules 314-1 and 314-2 may be used and the signal processing module 314-3 may not be used.

In other words, for example, first, initialization is performed such that all the signal processing modules 314-1 to 314-3 operate in step S102 in FIG. 34, and the signal processing modules 314-1 to 314-3 are controlled to independently process signals in the regions R1 to R3, respectively, in parallel. However, if a failure is found in the signal processing module 314-3, initialization is performed such that only the signal processing modules 314-1 and 314-2 operate in step S105. As a result, the signal processing module 314-1 processes only a signal in a left half region R11 obtained by dividing the frame 481 into half in the vertical direction, and the signal processing module 314-2 processes only a signal in a right half region R12 obtained by dividing the frame 481 into half in the vertical direction, as shown in FIG. 42B. Accordingly, a situation in which only an image corresponding to the region R3 in FIG. 42A is not displayed can be prevented. In this case, although the processing speed is reduced, this processing is preferable in terms of a user interface compared with a case where part of an image is not displayed.

Although a case where the present invention is applied to a television receiver has been described, the present invention is also applicable to various other information processing apparatuses.

The sections from the image quality detector 321 to the image quality adjustor 325 may be arranged on respective substrates or on a common substrate to be installed in an apparatus. Alternatively, each of the sections from the image quality detector 321 to the image quality adjustor 325 may be an individual section.

The foregoing series of processing may be performed by hardware or software. When the series of foregoing processing is performed by software, a program constituting the software is installed via a network or a recording medium on a computer built in dedicated hardware or a general-purpose personal computer (shown in FIG. 31) or the like capable of performing various functions by installing various programs.

As shown in FIGS. 32 and 41, a recording medium not only includes the removable medium 316, such as a magnetic disk (including a flexible disk), an optical disk (including a CD-ROM and a DVD), a magneto-optical disk (including an MD), or a semiconductor memory, which records the program and is distributed in order to provide the program to a user independent of an apparatus main unit, but also includes a ROM or a hard disk, which records the program and is built in the apparatus main unit to be provided to the user.

In this embodiment, steps for a program recorded in a recording medium are not necessarily performed in chronological order in accordance with the written order. The steps may be performed in parallel or independently without being performed in chronological order.

In addition, in this embodiment, a system means the whole equipment including a plurality of apparatuses.

It should be understood by those skilled in the art that various modifications, combinations, sub-combinations and alterations may occur depending on design requirements and other factors insofar as they are within the scope of the appended claims or the equivalents thereof.

1. An information processing apparatus comprising:
acquisition means for acquiring input and output signal formats from each of connected signal processing apparatuses;
selection means for selecting a first apparatus from among the signal processing apparatuses;
creation means for selecting, from among the signal processing apparatuses, a second apparatus having an input signal format corresponding to an output signal format of the selected first apparatus and for creating a signal path table including a signal path in which the second apparatus is described as an apparatus that receives a processed signal output from the first apparatus; and
display means for controlling display of the signal path created in the signal path table.

2. The information processing apparatus according to claim 1, wherein:
the selection means selects an external input apparatus for receiving an external processed signal as the first apparatus, and selects an intermediate apparatus that is not the external input apparatus and that is not an external output apparatus for externally outputting the processed signal after the signal path table for the external input apparatus is created; and
the creation means creates a signal path table including a signal path in which the intermediate apparatus is described as the first apparatus after the signal path table for the external input apparatus is created.

3. The information processing apparatus according to claim 2, wherein the creation means eliminates a signal processing apparatus for which the signal path is not established from the signal path table after the signal path table for the intermediate apparatus is created.

4. The information processing apparatus according to claim 1, further comprising determination means for determining a signal path in accordance with priorities when the signal path table includes a plurality of signal paths.

5. The information processing apparatus according to claim 4, wherein the determination means determines the priorities in accordance with the weight provided in advance to each of the signal processing apparatuses.

6. The information processing apparatus according to claim 4, wherein the determination means determines the priorities in accordance with a signal path assumed for each of the signal processing apparatuses.

7. The information processing apparatus according to claim 1, wherein:
when a first mode is selected, the display means displays a first parameter input screen for setting a parameter in detail; and
when a second mode is selected, the display means displays a second parameter input screen for easily setting a parameter.

8. An information processing method comprising the steps of:
acquiring input and output signal formats from each of connected signal processing apparatuses;
selecting a first apparatus from among the signal processing apparatuses;
selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and
controlling display of the signal path created in the signal path table.

9. A recording medium on which a computer-readable program is recorded, the program comprising the steps of:
acquiring input and output signal formats from each of connected signal processing apparatuses;
selecting a first apparatus from among the signal processing apparatuses;
selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and
controlling display of the signal path created in the signal path table.

10. A program for causing a computer to perform the steps of:
acquiring input and output signal formats from each of connected signal processing apparatuses;
selecting a first apparatus from among the signal processing apparatuses;
selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and
controlling display of the signal path created in the signal path table.

11. An information processing apparatus comprising:
output means for outputting a broadcast control signal;
a plurality of processing means for processing a signal input from a previous stage and outputting the processed signal to a subsequent stage when the broadcast control signal is received and for outputting an error signal when the processed signal is not received from the previous stage within a predetermined time set in advance after receiving the broadcast control signal;
reception means for receiving the error signal output from each of the plurality of processing means; and
determination means for determining which processing means from among the plurality of processing means has a failure in accordance with the error signal received by the reception means.

12. The information processing apparatus according to claim 11, wherein the plurality of processing means outputs the processed signal and a synchronous control signal that is equal to the broadcast control signal to the subsequent stage.

13. An information processing method comprising the steps of:
performing a plurality of processings for processing a signal input from a previous stage and outputting the processed signal to a subsequent stage when a broadcast control signal is received and for outputting an error signal when the processed signal is not received from the previous stage within a predetermined time set in advance after receiving the broadcast control signal;
receiving the error signal output by each of the plurality of processings; and
determining which processing from among the plurality of processings has a failure in accordance with the error signal received by the receiving step.

14. A recording medium on which a computer-readable program is recorded, the program comprising the steps of:
performing a plurality of processings for processing a signal input from a previous stage and outputting the processed signal to a subsequent stage when a broadcast control signal is received and for outputting an error signal when the processed signal is not received from the previous stage within a predetermined time set in advance after receiving the broadcast control signal;
receiving the error signal output by each of the plurality of processings; and
determining which processing from among the plurality of processings has a failure in accordance with the error signal received by the receiving step.

15. A program for causing a computer to perform the steps of:
performing a plurality of processings for processing a signal input from a previous stage and outputting the processed signal to a subsequent stage when a broadcast control signal is received and for outputting an error signal when the processed signal is not received from the previous stage within a predetermined time set in advance after receiving the broadcast control signal;
receiving the error signal output by each of the plurality of processings; and
determining which processing from among the plurality of processings has a failure in accordance with the error signal received by the receiving step.

16. An information processing apparatus comprising:
an acquisition unit acquiring input and output signal formats from each of connected signal processing apparatuses;
a selection unit selecting a first apparatus from among the signal processing apparatuses;
a creation unit selecting, from among the signal processing apparatuses, a second apparatus having an input signal format corresponding to an output signal format of the selected first apparatus and creating a signal path table including a signal path in which the second apparatus is described as an apparatus that receives a processed signal output from the first apparatus; and
a display unit controlling display of the signal path created in the signal path table.

17. An information processing apparatus comprising:
an output unit outputting a broadcast control signal;
a plurality of processing units processing a signal input from a previous stage and outputting the processed signal to a subsequent stage when the broadcast control signal is received and outputting an error signal when the processed signal is not received from the previous stage within a predetermined time set in advance after receiving the broadcast control signal;
a reception unit receiving the error signal output from each of the plurality of processing units; and
a determination unit determining which processing unit from among the plurality of processing units has a failure in accordance with the error signal received by the reception unit.
